(19) United States
(12) Patent Application Publication
(10) Pub. No.: US 2026/0358825 A1
(43) Pub. Date: Nov. 12, 2026

(54) SYSTEM AND METHOD FOR TRACKING MOVEMENT OF MACHINES BETWEEN PREDEFINED ZONES

(71) Applicant: Caterpillar Inc., Peoria, IL (US)

(72) Inventors: Peter Broughton, Maryborough (AU); Benjamin Michael Godfrey, Brunswick West (AU); Jason Gough, Ulverstone (AU)

(73) Assignee: Caterpillar Inc., Peoria, IL (US)

(21) Appl. No.: 19/201,996

(22) Filed: May 8, 2025

(51) Int. Cl. G05D 1/65; G05D 1/617; E05F 15/70; G05D 107/90

(52) U.S. Cl. CPC G05D 1/65; G05D 1/617; E05F 15/70; G05D 2107/90

(57) ABSTRACT

A system for tracking movement of machine(s) between predefined zones is disclosed. The system includes at least two barriers positioned at an entry/exit of a zone and a barrier controller in communication with the machine(s). The machine is configured to monitor a distance of the machine from the barriers, calculate a difference between the monitored distances, and provide the monitored distances and/or the calculated difference to the controller. The controller is configured to monitor a barrier state of the barriers, determine an incursion of the barriers, and/or an order of the incursion the barriers based on the monitored barrier state. Further, the controller is configured to correlate the determined incursion or the order of the incursion with the calculated difference and/or the monitored distances, and determine a position, location, and/or an orientation of the machine within or outside of the zone based on the correlation.

### TECHNICAL FIELD

The present disclosure relates, in general, to managing machine movements. More particularly, the present disclosure relates to a system and a method for tracking the movement of machines between predefined zones.

### BACKGROUND

Typically, in a worksite such as an underground mine site several machines may be assigned to operate in isolation in different zones within the worksite. However, for instances when the machines are to be reassigned to different zones or moved between the zones, it may be important to set up adequate safety measures within the worksite to prevent undesirable events such as accidents between machines and/or harm to personnel operating in the worksite or in the vicinity of the zones. Conventional safety measures include isolating the machines to operate only in the assigned zones and restrict movement of the machines between the zones. However, the localized operation of the machines with lack of flexibility to move between the zones may impact productivity and production efficiency. Tracking the machines operating within the zones may also be difficult, particularly in the underground mine site, due to intermittent or loss of wireless network connectivity at times. Decentralized tracking methods such as sensor-based alerts may also be implemented within the worksite to track the movement of the machines. However, the safety measures implemented based on such decentralized tracking methods may be inadequate since it may be difficult to determine an actual position or location of the machines, the zone of operation of the machines, and/or the movement of the machines between the specific zones within the worksite. Furthermore, failure of such decentralized tracking methods involving, for example, sensors may also go undetected. Consequently, safety of machines and personnel within the worksite may continue to be compromised due to lack of specific information related to machine position, location, or direction of movement within the worksite and/or the failure of the decentralized tracking methods involving, for example, sensors.

PCT publication WO2025208932, herein referred to as the “WO ‘932 reference”, relates to an apparatus and a method for controlling operation of a work machine connected to a first safety system configured to monitor safety of an isolated operating area and a second safety system configured to monitor a pre-determined volume surrounding, at least partly, the work machine operating in the isolated operating area. The method comprises receiving an indication, from the first safety system associated with the isolated operating area, that a safety operation is to be performed for the work machine operating in the isolated operating area, determining, in response to receiving the indication, a status of a second safety system associated with the work machine, determining, based on the safety operation and the status of the second safety system associated with the work machine, an adapted safety operation, and controlling operation of the work machine based on the adapted safety operation. That is, the WO ‘932 reference relates to safety operations to be performed on the machine within the isolated operating area. However, the safety systems of the WO ‘932 reference may be inadequate for tracking movements of the machine between the isolated operating areas and thereby, ensuring safety of machines/personnel during such movements.

### SUMMARY

In an aspect of the present disclosure, a system for tracking movement of at least one machine between predefined zones in a worksite is disclosed. The system includes a first barrier positioned at an entry or an exit of at least one zone of the predefined zones respectively and a second barrier positioned at a predefined distance from the first barrier after the entry or the exit. The system also includes at least one controller associated with the first barrier and the second barrier and the at least one machine in communication with the at least one controller. The at least one machine is assigned to move across the at least one zone and is configured to monitor, via a processor of the at least one machine and the at least one controller, a first distance and a second distance of the at least one machine from the first barrier and the second barrier respectively. The at least one machine is also configured to calculate, via the processor, a difference between the monitored first distance and the monitored second distance. Further, the at least one machine is also configured to provide, via the processor, at least one of the monitored first distance, the monitored second distance, or the calculated difference to the at least one controller. The at least one controller is configured to monitor a barrier state of the first barrier, the second barrier, or both the first and the second barriers. The barrier state is indicative of a presence, an absence, or an incursion of the first barrier, the second barrier, or both the first and the second barriers. The at least one controller is also configured to monitor the incursion of the first barrier, the second barrier, both the first barrier and the second barrier, and/or an order of the incursion of the first barrier and the second barrier by the at least one machine based on the monitored barrier state. Further, the at least one controller is configured to correlate the monitored incursion and/or the monitored order of the incursion with the calculated difference, the monitored first distance, the monitored second distance, or any combination thereof received from the at least one machine. In addition, the at least one controller is configured to determine a position, location, and/or an orientation of the at least one machine within or outside of the at least one zone based on the correlation.

In another aspect of the present disclosure, a control system for tracking movement of at least one machine between predefined zones in a worksite is disclosed. The system comprises a processor and a memory for storing instructions, that when executed by the processor, causes the processor receive, via at least two barriers provided at an entry/exit of at least one zone of the predefined zones, a barrier state of the at least two barriers. The barrier state is indicative of at least one of a presence, an absence, or an incursion of at least one of the at least two barriers. Further, the processor is configured to determine the incursion of at least one of the at least two barriers, and/or an order of the incursion of the at least two barriers by the at least one machine based on the received barrier state. The processor is also configured to receive, via the at least one machine, a distance of the at least one machine from the at least two barriers respectively. In addition, the processor is configured to calculate a difference between the received distance of the at least one machine from the at least two barriers respectively. Furthermore, the processor is also configured to correlate the determined incursion or the determined order of the incursion with the calculated difference, the received distance, or any combination thereof and determine a position, a location, and/or an orientation of the at least one machine within or outside of the at least one zone based on the correlation.

In yet another aspect of the present disclosure, a method for tracking movement of at least one machine between predefined zones in a worksite is disclosed. The method includes a step of monitoring, via a processor of the at least one machine and at least one controller associated with a first barrier and a second barrier, a first distance and a second distance of the at least one machine from the first barrier and the second barrier respectively. The first barrier and the second barrier are provided at an entry or an exit of at least one zone of the predefined zones. The method also includes a step of calculating, via the processor, a difference between the monitored first distance and the monitored second distance. Further, the method includes a step of providing, via the processor, at least one of the monitored first distance, the monitored second distance, or the calculated difference to the at least one controller. In addition, the method includes a step of monitoring, via the at least one controller, a barrier state of the first barrier and/or the second barrier. The barrier state is indicative of a presence, an absence, or an incursion of the first barrier and/or the second barrier. Furthermore, the method includes a step of monitoring, via the at least one controller, the incursion of the first barrier and/or the second barrier, and/or an order of the incursion of the first barrier and the second barrier by the at least one machine based on the monitored barrier state. The method also includes correlating, via the at least one controller, the monitored incursion or the monitored order of the incursion with the calculated difference, the monitored first distance, the monitored second distance, or any combination thereof received from the at least one machine. Further, the method includes determining, via the at least one controller, a position, a location, and/or an orientation of the at least one machine within or outside of the at least one zone based on the correlation.

### BRIEF DESCRIPTION OF DRAWINGS

FIG. 1 is an exemplary illustration of an environment, in accordance with which various embodiments of the present disclosure are implemented;

FIGS. 2-4 are exemplary illustrations of an exemplary system for tracking movement of a machine moving across predefined zones within a worksite, in accordance with the embodiments of the present disclosure;

FIG. 5 is an exemplary schematic block diagram of the machine of FIGS. 1-4 in communication with barriers provided at an entry/exit of a zone and a barrier controller associated with the barriers, in accordance with the embodiments of the present disclosure;

FIGS. 6-10 are exemplary illustrations of the machine of FIG. 4 monitoring the distance of the machine from barriers provided at an entry/exit of a zone, in accordance with the embodiments of the present disclosure;

FIG. 11, is an exemplary schematic block diagram of a barrier controller employed within the environment of FIG. 1 and in communication with an isolation barrier provided at the entry/exit of a zone and the machine of FIG. 5, in accordance with the embodiments of the present disclosure;

FIG. 12 is an exemplary schematic block diagram of a controller employed within the environment of FIG. 1 and in communication with barriers provided at an entry/exit of a zone and the machine of FIG. 5, in accordance with the embodiments of the present disclosure;

FIG. 13 is an exemplary method for tracking movement of the machine of FIG. 5 between predefined zones within a worksite, in accordance with the embodiments of the present disclosure;

FIGS. 14-16 are exemplary illustrations of the machine of FIG. 4 entering a zone in which another machine employed in the environment of FIG. 1 is currently operating; in accordance with the embodiments of the present disclosure;

FIGS. 17-19 are exemplary illustrations of the machine of FIG. 4 and another machine employed in the environment of FIG. 1 simultaneously entering a zone; in accordance with the embodiments of the present disclosure; and

FIGS. 20-22 are exemplary illustrations of the machine of FIG. 4 entering a zone and another machine, employed within the environment of FIG. 1, exiting the zone simultaneously; in accordance with the embodiments of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1`, 1``, 101 and 201 could refer to one or more comparable components used in the same and/or different depicted embodiments.

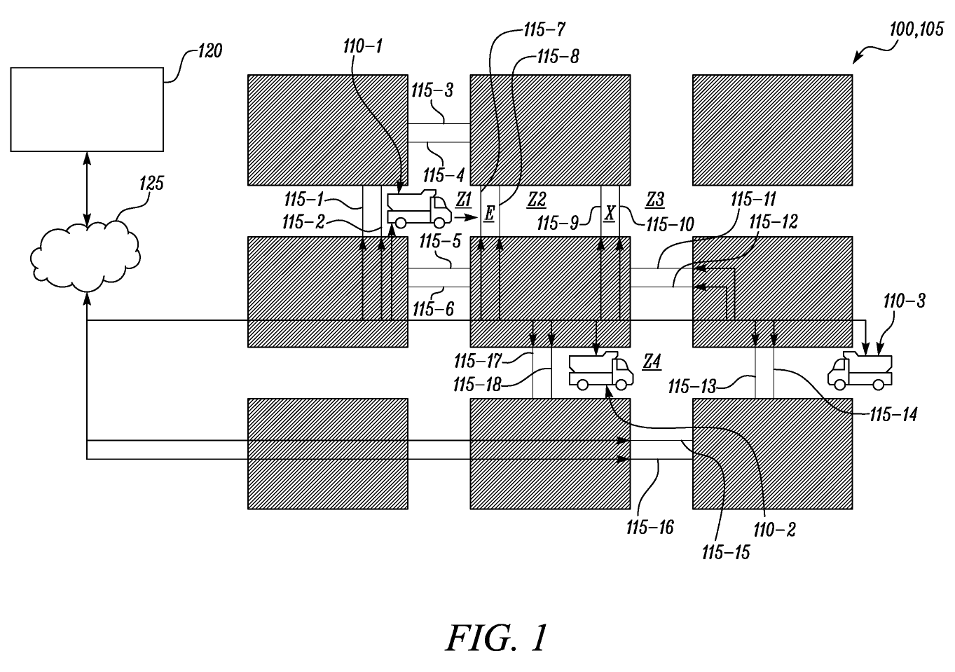

Referring to FIG. 1, an environment 100, herein referred to as the ‘worksite 100’ disclosed. Examples of the worksite 100 include, but are not limited to, an underground mine site, a road construction site, a landfill, a quarry, a construction site, or any other type of worksite. The worksite 100 employs a system 105 for tracking movement of at least one machine, for example, 110-1 through 110-3, moving across predefined zones, for example, Z1, Z2, Z3, Z4 within the worksite 100. In embodiments, the at least one machine, for example, 110-1 through 110-3, is an autonomous machine, a semi-autonomous machine, or a manually controlled machine, such as those operated by an operator. Examples of the at least one machine, for example, 110-1 through 110-3, include, but are not limited to, haul trucks, water trucks, loaders, excavators, shovels, tractors, graders, light vehicles, and other service vehicles now known or in future developed. In embodiments, the predefined zones, for example, Z1 through Z4, correspond to armed zones, armed machine zones, and disarmed zones. In embodiments, the armed zones correspond to isolated zones identified for machine operation and/or isolated zones in which only machines, for example, 110-1, are allowed to operate, the armed machine zones correspond to isolated zones in which one or more machines are currently operating or operational or isolated zones in which the machines have entered the zone(s), and the disarmed zones correspond to zones in which both the machine(s), for example, the manually controlled machines, and/or the personnel/human operators are allowed to operate. For example, the zone Z1 corresponds to the armed machine zone when the machine 110-1 is currently operating or operational in the zone Z1, the zone Z2 corresponds to the armed zone identified for machine operation, and the zone Z3 corresponds the disarmed zone in which both the machine(s) and/or the personnel/human operators are allowed to operate.

In embodiments, the system 105 includes the at least one machine, for example, 110-1 through 110-3 configured to operate within the worksite 100 and traverse the predefined zones, for example, Z1 through Z4. The system 105 also includes at least two barriers, for example, 115-1 through 115-18, herein referred to as “isolation barriers”, provided at different locations within the worksite 100 to isolate the predefined zones, for example, Z1 through Z4. In embodiments, the at least two barriers, for example, 115-7, 115-8 are provided at an entry or entry zone ‘E’ and/or the at least two barriers, for example, 115-9, 115-10 provided at an exit or exit zone ‘X’ of at least one zone, for example, Z2 of the predefined zones, for example, Z1 through Z4. Examples of the isolation barriers, for example, 115-1 through 115-18 include, but are not limited to, physical barriers, light curtains/screens, laser sensors, and other mechanical, electronic, and/or opto-electronic devices. In embodiments, the isolation barriers, for example, 115-1 through 115-18, are configured to detect an incursion of the isolation barriers by at least one object including, but not limited to, the at least one machine, for example, 110-1 through 110-3 and/or a human operator. In embodiments, the isolation barriers, for example, 115-1 through 115-8 correspond to passage control units (PCUs) configured to detect and control movement of the object(s) into or out of the predefined zones, for example, Z1 through Z4 respectively. In addition, the system 105 includes at least one controller or control system, for example, 120 in communication with the isolation barriers, for example, 115-1 through 115-18 and the at least one machine, for example, 110-1 through 110-3 via a network 125. It may be understood by those with ordinary skill in the art that, although a single controller, for example, 120 is illustrated, the system 105 is configured to include multiple interconnected controllers in communication with each other via the network 125. Examples of the at least one controller, for example, 120 include, but are not limited to, computers, laptops, mobile devices, handheld devices, personal digital assistants (PDAs), tablet personal computers, digital notebook, wearables, programmable logic controllers/industrial computers, and other electronic devices now known or in future developed. It will be understood by those with ordinary skill in the art that the at least one controller, for example, 120 may also correspond to one or more or a collection of virtual servers, physical servers, remote cloud servers, on-premises cloud servers, and other servers presently known or in future developed. Examples of the network 125 include, but are not limited to, a Local Area Network (LAN), a Wireless Local Area Network (WLAN), a Small Area Network (SAN), a Wi-Fi Direct Network, a telecommunication network including, but not limited to, a fourth generation (4G) and a fifth generation (5G) cellular network, and any communication network for data communication presently known or in future developed. In embodiments, the system 105 is configured to track a location, position, and/or an orientation of the at least one machine, for example, 110-1 within the worksite 100 and/or within or in proximity to the isolation zones, for example, Z1 through Z4 within the worksite 100.

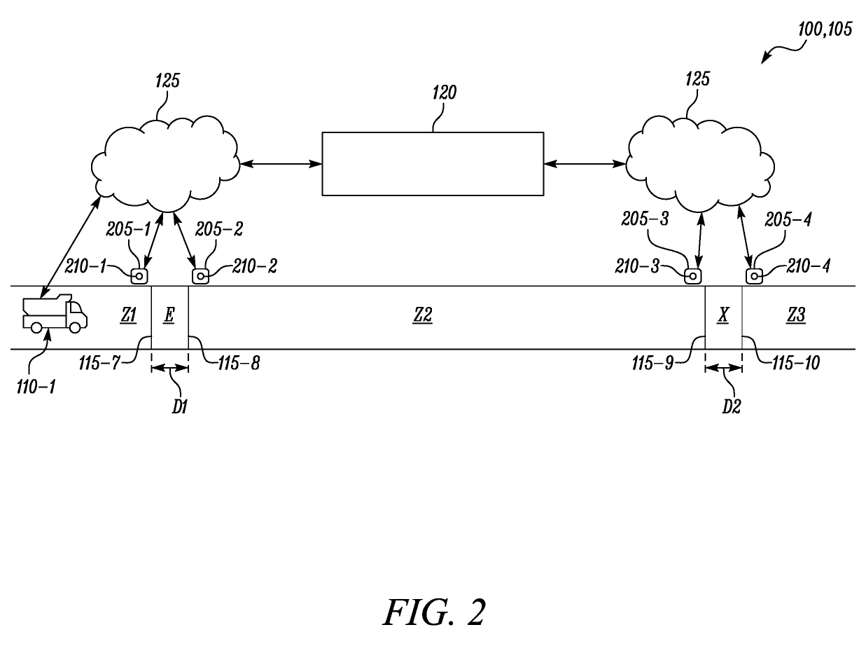

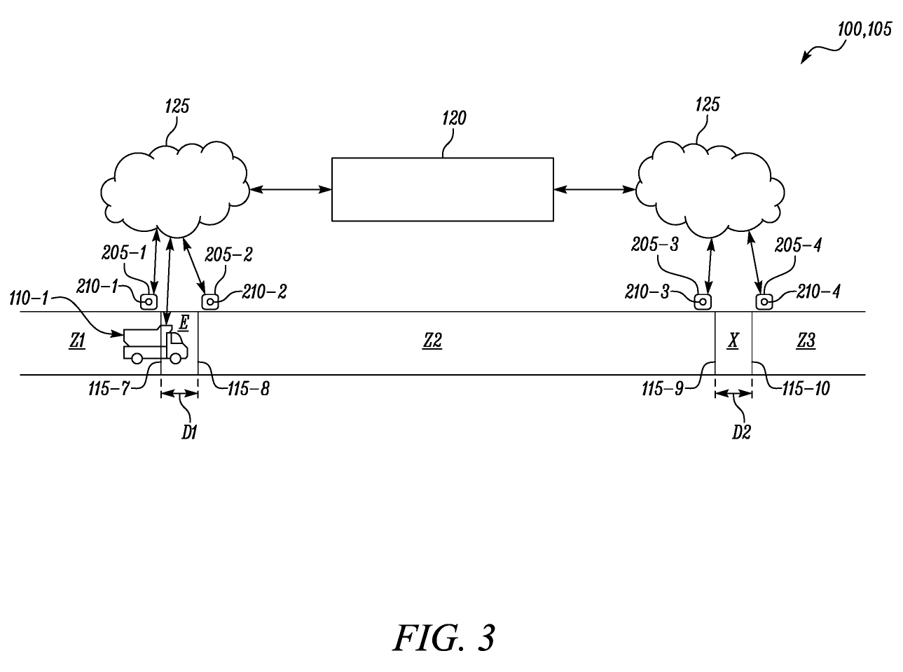

Referring to FIGS. 2-4, exemplary illustrations of the system 105 for tracking movement of the at least one machine, for example, 110-1 moving across predefined zones, for example, Z1 through Z3 within the worksite 100 is disclosed. In embodiments, the zone, for example, Z1 including the machine 110-1 corresponds to the armed machine zone, the zone, for example, Z2 identified for machine operation corresponds to the armed zone, and the zone, for example, Z3 in which both machine(s), for example, 110-1 through 110-3 and personnel/human operators are allowed to operate corresponds to the disarmed zone. In embodiments, the zone Z2 includes a first isolation barrier, for example, 115-7 at the entry or the entry zone ‘E’ of the zone Z2 and a second isolation barrier, for example, 115-8 at a predefined distance ‘D1’ from the first isolation barrier, for example, 115-7 after the entry or entry zone ‘E’. In embodiments, the zone Z2 also includes a third isolation barrier, for example, 115-9 at the exit or the exit zone ‘X’ of the zone Z2 and a fourth isolation barrier, for example, 115-10 at the predefined distance ‘D2’ from the third isolation barrier, for example, 115-9 after the exit or exit zone ‘X’.

In embodiments, the system 105 is also configurable to include at least one barrier controller, for example, 205-1 through 205-4 in communication with and configured to operate the at least one isolation barrier, for example, 115-7. In embodiments, the system 105 is also configured to include the barrier controller, for example, 205-1 for each isolation barrier, for example, 115-7, 115-8, 115-9, 115-10. In some embodiments, the at least one barrier controller, for example, 205-1 through 205-4 is in communication with the at least one controller, for example, 120 via the network 125. In embodiments, the at least one barrier controller, for example, 205-1 through 205-4 is also configurable to include one or more barrier state visual indicators, for example, 210-1 through 210-4 to indicate a barrier state of the isolation barriers, for example, 115-7, 115-8, 115-9, 115-10 respectively. In embodiments, the barrier state of the isolation barriers, for example, 115-7, 115-8, 115-9, 115-10 is indicative of a presence or an absence, a placing or a removal, an activation or deactivation, or an incursion of the isolation barriers, for example, 115-7, 115-8, 115-9, 115-10. In embodiments, the barrier state visual indicator(s), for example, 210-1 through 210-4 are configured to display one or more colors to display the barrier state. In embodiments, the barrier state visual indicator(s), for example, 210-1 through 210-4 are configured to display different colors to indicate the different barrier states. It will be apparent to those with ordinary skill in the art that although the barrier controllers, for example, 205-1 through 205-4 associated with the isolation barriers, for example, 115-7 through 115-10 are shown as separate units, in some embodiments, the isolation barriers, for example, 115-7 through 115-10 are configurable to include the at least one barrier controller, for example, 205-1 as single integrated unit configured to control the isolation barriers, for example, 115-7 through 115-10. Similarly, it will also be apparent to those with ordinary skill in the art that although each isolation barrier, for example, 115-7 and the correspondingly associated barrier controller, for example, 205-1 are shown as separate units, the barrier controller, for example, 205-1 and the isolation barrier, for example, 115-7 are configurable to be integrated as a single unit.

In some embodiments, the at least one controller, for example, 120 is configured to operate the isolation barriers, for example, 115-7, 115-8, 115-9, 115-10. In embodiments, the at least one controller, for example, 120 is configured to operate the isolation barriers, for example, 115-7, 115-8, 115-9, 115-10, via, the at least one barrier controller, for example, 205-1 through 205-4. In some embodiments, the at least one barrier controller, for example, 205-1 through 205-4 is configured to operate the isolation barriers, for example, 115-7, 115-8, 115-9, 115-10 independent of the at least one controller, for example, 120. In embodiments, the at least one controller, for example, 120 and/or the at least one barrier controller, for example, 205-1 through 205-4 are configured to activate or deactivate, or place or remove the isolation barriers, for example, 115-7, 115-8, 115-9, 115-10 from the entry or the entry zone ‘E and/or the exit or the exit zone ‘X’ of the predefined zones, for example, Z1 through Z3. In embodiments, each isolation barrier, for example, 115-7 is configured to provide the network 125 including, but not limited to, a radio frequency (RF) network. In embodiments, each isolation barrier, for example, 115-7 is configured to provide the network 125, for example, the RF network via the at least one barrier controller, for example, 205-1. In embodiments, the at least one machine, for example, 110-1 is configured to establish communication with the isolation barriers, for example, 115-7, 115-8, and/or the at least one barrier controller, for example, 205-1, 205-2, via the network 125, for example, the RF network provided by each isolation barrier, for example, 115-7, 115-8. In embodiments, the network 125 provided by each isolation barrier, for example, 115-7 is different from the network 125 enabling communication between each isolation barrier, for example, 115-7 or the at least one machine, for example, 110-1 and the at least one controller, for example, 120.

In embodiments, the at least one controller, for example, 120 is configured to receive at least one input from the at least one machine, for example, 110-1 and the isolation barriers, for example, 115-7, 115-8 respectively to determine the location, the position, and/or the orientation of the at least one machine, for example, 110-1 within the worksite 100 and/or within or in proximity to the isolation zones, for example, Z1 through Z3 within the worksite 100 based on the at least one input received. In embodiments, the at least one controller, for example, 120 is also configurable to receive the at least one input from the isolation barriers, for example, 115-7, 115-8 via the barrier controllers, for example, 205-1, 205-2, associated with the isolation barriers, for example, 115-7, 115-8 respectively. As an example, the at least one controller, for example, 120 is configured to track the movement of the at least one machine, for example, 110-1 from the armed machine zone, for example, the zone Z1, to the armed zone, for example, the zone Z2 via the isolation barriers, for example, 115-7, 115-8 based on the at least one input from the at least one machine, for example, 110-1 and the isolation barriers, for example, 115-7, 115-8 respectively. For purposes of clarity and understanding, the functions performed by the machine 110-1 is described hereinafter. However, it will be understood by those with ordinary skill in the art that the remaining machines, for example, 110-2, 110-3 employed within the worksite 100 are also configurable to perform similar functions as the machine 110-1.

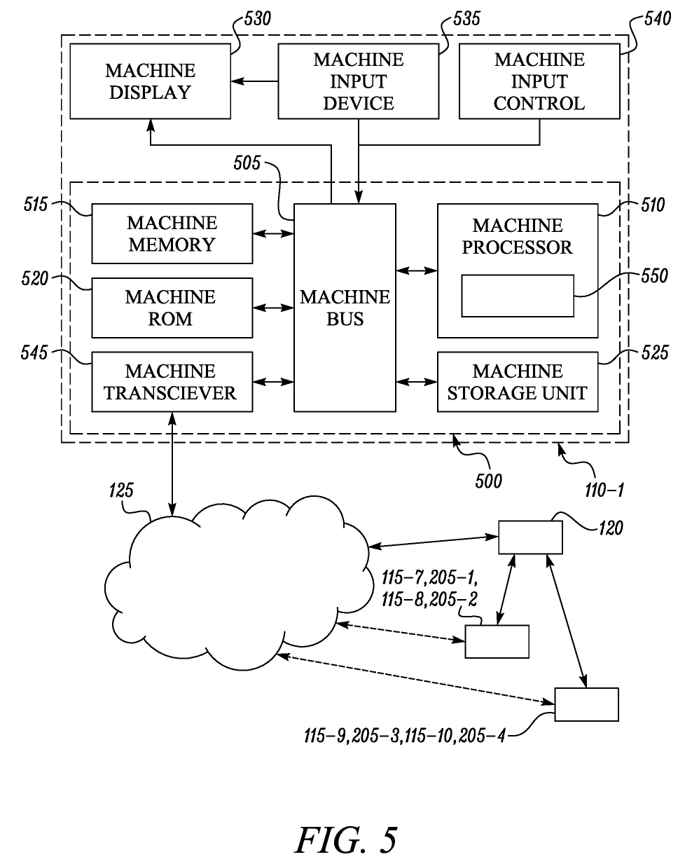

Referring to FIG. 5, an exemplary schematic block diagram of the machine 110-1 included in the system 105 of FIGS. 1-4 and employed within the worksite 100 of FIG. 1 is disclosed. The machine 110-1 includes a machine control system 500 in communication with the at least one controller, for example, 120. In embodiments, the machine control system 500 corresponds to a machine Electronic Control Module (ECM) configured to control one or more operations of the machine 110-1. Although a single machine control system 500 or ECM is illustrated, it will understood by those with ordinary skill in the art that the machine 110-1 is configurable to include multiple machine control systems or ECMs in communication with each other and configured to control different functions or operations of the machine 110-1 including, but not limited to, ECMs for controlling machine engine or ground speed, machine implement operation, and machine activation and/or shut-down operation. Alternative configurations of a single machine control system, for example, 500 in communication with and configured to control and receive inputs from one or more additional machine control systems or ECMs provided in the machine 110-1 is also contemplated.

The machine control system 500 includes a machine bus 505 or other communication mechanism for communicating information, and a machine processor 510 coupled with the machine bus 505 for processing information. The machine control system 500 also includes a machine memory 515, such as a random-access memory (RAM) or other dynamic storage device, coupled to the machine bus 505 for storing information and instructions to be executed by the machine processor 510. The machine memory 515 can be used for storing temporary variables or other intermediate information during execution of instructions to be executed by the machine processor 510. The machine control system 500 further includes a machine read-only-memory (ROM) 520 or other static storage device coupled to machine bus 505 for storing static information and instructions for the machine processor 510.

In embodiments, the machine control system 500 is also configurable to include a machine storage unit 525, such as, but not limited to, a magnetic disk, an optical disk, or a solid-state disk, coupled to the machine bus 505 to store information. Examples of the information include, but are not limited to, a unique machine identifier associated with the machine 110-1, a unique barrier identifier associated with the isolation barriers, for example, 115-7, 115-8, 115-9, 115-10 or the barrier controllers, for example, 205-1 through 205-4 (see FIG. 2) respectively, a distance of the machine 110-1 from the isolation barriers, for example, 115-7, 115-8, a difference in the distance of the machine 110-1 from the isolation barriers, for example, 115-7, 115-8, a geographic route map of the worksite 100 including, but not limited to, geographic locations of the predefined zones, for example Z1 through Z4 within the worksite 100, and/or a position, location, and/or an orientation of the machine 110-1 within the worksite 100. It may be understood that the information stored in the machine storage unit 525 may be accessed by the machine processor 510 via the machine memory 515 to perform one or more functions.

The machine control system 500 can be coupled via the machine bus 505 to a machine display 530 such as, but not limited to, a light emitting diode (LED) and a liquid crystal display (LCD), for displaying information to an operator of the machine control system 500. A machine input device 535 is coupled to machine bus 505 for communicating information and command selections to the machine processor 510. In embodiments, the machine input device 535 is also configurable to be included in the machine display 530, for example, a touch screen that facilitates detection of multi-touch inputs from a user via the machine display 530. The machine input device 535 is also configurable to include peripheral input devices capable of being paired with the machine control system 500 via the network 125, for example, a wireless network including, but not limited to, a Bluetooth, Wi-Fi, or a Wi-Fi direct network, or as a wired network or hardware connection such as, but not limited to, a USB peripheral to the machine control system 500. Examples of the peripheral input devices include, but are not limited to, a joystick, a gamepad, a keyboard, a mouse, a gesture-controlled device, or a wearable device such as, for example, a smart watch. In embodiments, the machine input device 535 is also configurable to include a microphone (not shown) provided in the machine control system 500 that is configured to received audio inputs or instructions from the operator(s) of the machine control system 500. In embodiments, the machine input device 535 is also configurable to include alphanumeric and other keys. Another type of user input device is a machine input control 540, such as a mouse, a trackball, or cursor direction keys for communicating direction information and command selections to the machine processor 510 and for controlling cursor movement on the machine display 530.

Various embodiments are related to the use of machine control system 500 for implementing the techniques described herein. In one embodiment, the techniques are performed by the machine control system 500 in response to the machine processor 510 executing instructions included in the machine memory 515. Such instructions can be read into the machine memory 515 from another machine-readable medium, such as the machine storage unit 525. Execution of the instructions included in the machine memory 515 causes the machine processor 510 to perform the process steps described herein.

The term “machine-readable medium” as used herein refers to any medium that participates in providing data that causes a machine to operate in a specific fashion. In an embodiment implemented using the machine control system 500, various machine-readable medium is involved, for example, in providing instructions to the machine processor 510 for execution. The machine-readable medium can be a storage media. Storage media includes both non-volatile media and volatile media. Non-volatile media includes, for example, optical, magnetic, or solid-state disks, such as the machine storage unit 525. Volatile media includes dynamic memory, such as the machine memory 515. All such media must be tangible to enable the instructions carried by the media to be detected by a physical mechanism that reads the instructions into a machine. Common forms of machine-readable medium include, for example, a floppy disk, a flexible disk, hard disk, magnetic tape, a solid-state disk, or any other magnetic medium, a CD-ROM, any other optical medium, punch cards, paper-tape, any other physical medium with patterns of holes, a RAM, a PROM, and EPROM, a FLASH-EPROM, any other memory chip, or cartridge.

In another embodiment, the machine-readable medium can be a transmission media including coaxial cables, copper wire and fibre optics, including the wires that include the machine bus 505. Transmission media can also take the form of acoustic or light waves, such as those generated during radio-wave and infra-red data communications. Examples of machine-readable medium include, but are not limited, to a carrier wave as described hereinafter or any other medium from which the machine control system 500 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the machine control system 500 can receive the data on the telephone line and use an infra-red transmitter to convert the data to an infra-red signal. An infra-red detector can receive the data carried in the infra-red signal and appropriate circuitry can place the data on the machine bus 505. The machine bus 505 carries the data to the machine memory 515, from which the machine processor 510 retrieves and executes the instructions. The instructions received by the machine memory 515 can optionally be stored in the machine storage unit 525 either before or after execution by the machine processor 510.

The machine control system 500 also includes a machine transceiver 545 coupled to the machine bus 505. The machine transceiver 545 provides a two-way data communication coupling with the at least one controller, for example, 120, and the isolation barriers, for example, 115-7, 115-8, 115-9, 115-10 and/or the barrier controllers, for example, 205-1 through 205-4 (see FIG. 2). For example, the machine transceiver 545 can be an integrated service digital network (ISDN) card or a modem to provide a data communication connection to a corresponding type of telephone line. As another example, the machine transceiver 545 can be a local area network (LAN) card to provide a data communication connection to a compatible LAN. Wireless links can also be implemented. In any such implementation, the machine transceiver 545 sends and receives radio, electrical, electromagnetic, or optical signals that carry digital data streams representing various types of information. It will be understood by those with ordinary skill in the art that although the machine transceiver 545 is illustrated as a single unit, the machine transceiver 545 may include separate transmitter and receiver circuitry and/or components in communication with each other via the machine bus 505.

In embodiments, the machine processor 510 may be capable of executing the computer instructions stored in the machine memory 515 to perform one or more functions. In embodiments, the machine processor 510 may include one or more modules to perform the one or more functions. For example, the machine processor 510 may include a machine monitoring module 550. It may be understood that the module(s), for example, 550 may correspond to and/or include hardware and/or software components respectively and may be configured to perform respective functions.

In embodiments, the machine monitoring module 550 is configured to detect the isolation barriers, for example, 115-7, 115-8, provided at the entry or the entry zone ‘E’ (see FIGS. 2-4) of the zone Z2 (see FIGS. 2-4), when the machine transceiver 545 is within a network range of the network 125, for example the RF network provided by the isolation barriers, for example, 115-7, 115-8 and the machine transceiver 545 receives signals, for example, but not limited to, RF signals from the isolation barriers, for example, 115-7, 115-8. In embodiments, the machine monitoring module 550 is also configured determine a unique barrier identifier associated with each isolation barrier, for example, 115-7, 115-8 based on the received signals and the store the determine unique barrier identifier in the machine storage unit 525. In embodiments, upon receiving and/or storing the unique barrier identifier received from the isolation barrier, for example, 115-7, 115-8 and prior to the entry into the zone Z2 from the zone Z1, the machine monitoring module 550 is also configured to transmit one or more first signal(s) including the received unique barrier identifier to the at least one controller, for example, 120 (see FIGS. 2-4). In embodiments, the machine monitoring module 550 is also configured to transmit signals, for example, but not limited to, RF signals to the isolation barriers, for example, 115-7, 115-8 and/or the at least one barrier controller, for example, 205-1, 205-2 (see FIG. 2). In embodiments, the machine monitoring module 550 is configured to transmit one or more second signals including a unique machine identifier to the isolation barriers, for example, 115-7, 115-8 and/or the at least one barrier controller, for example, 205-1, 205-2. In embodiments, the machine monitoring module 550 is also configured to transmit the second signal(s) to the at least one controller, for example, 120 via the network 125. In embodiments, the machine monitoring module 550 is also configured to transmit the second signal(s) to the at least one controller, for example, 120 upon detection of the isolation barriers, for example, 115-7, 115-8 and prior to the entry into the zone Z2 from the zone Z1. In embodiments, the machine monitoring module 550 is configured to transmit one or more third signals to monitor a distance of the machine 110-1 from the isolation barriers, for example, 115-7, 115-8 and/or the at least one barrier controller, for example, 205-1, 205-2 via the machine processor 510 based on RF ranging. In embodiments, the machine monitoring module 550 is configured to monitor, via the machine processor 510, the distance of the machine 110-1 from the at least two isolation barriers, for example, 115-7, 115-8.

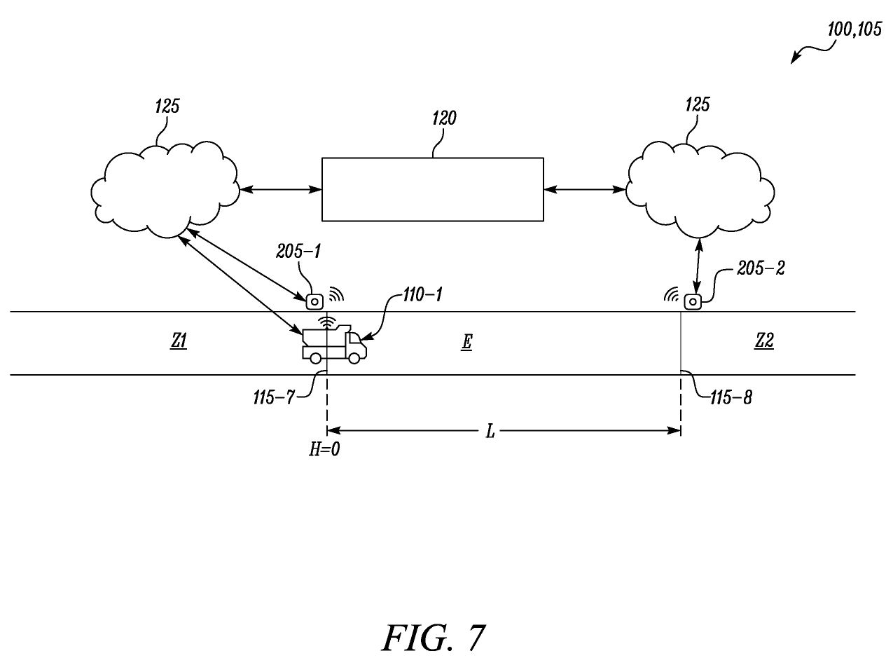

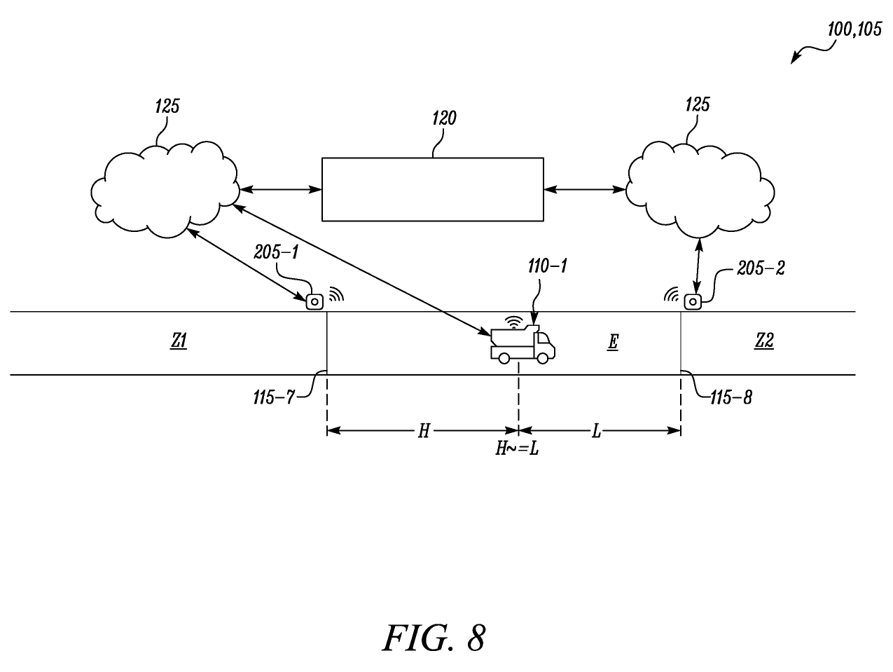

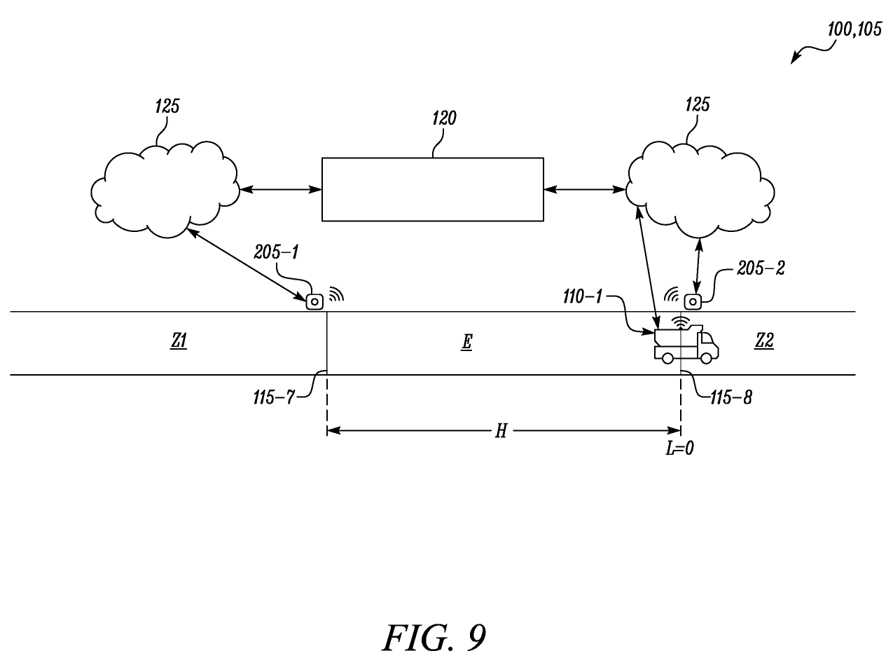

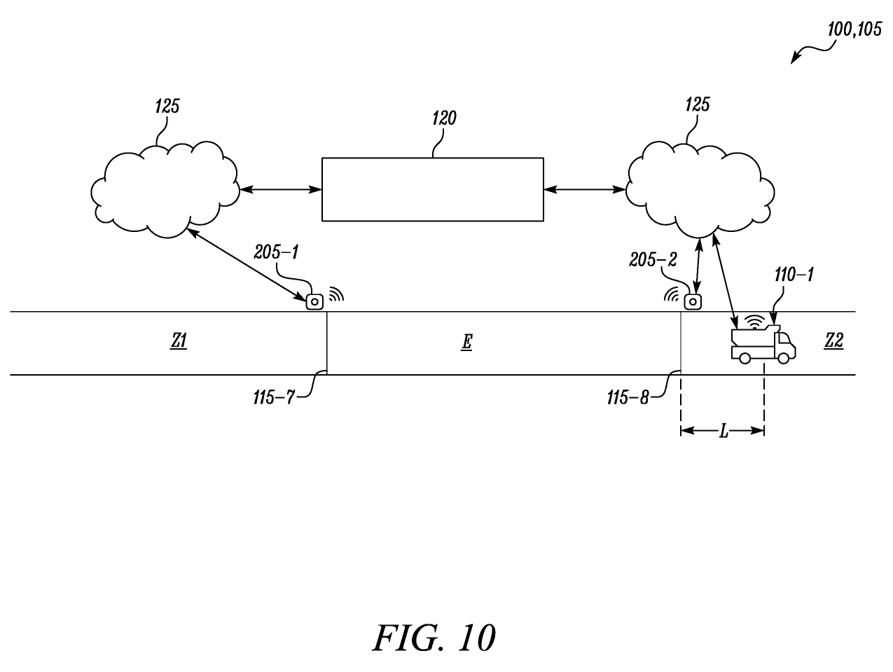

For example, referring to FIGS. 5, 6-10 when the machine 110-1 is moving from the zone Z1 towards the zone Z2, the machine monitoring module 550 is configured to detect and monitor a first distance ‘H’ and a second distance ‘L’ of the machine 110-1 from the first isolation barrier, for example, 115-7 and the second isolation barrier, for example, 115-8 respectively. The monitored first distance at or after a first instance of detection of the first isolation barrier, for example, 115-7 by the machine monitoring module 550 corresponds to an entry distance determined by the machine monitoring module 550. In embodiments, the machine monitoring module 550 is also configured to calculate, via the machine processor 510, a difference between the monitored first distance ‘H’ and the monitored second distance ‘L’. In embodiments, the calculated difference represented as, for example, ‘H’ – ‘L’, corresponds to a negative value when the first isolation barrier, for example, 115-7 is closer to the machine 110-1 in comparison to the second isolation barrier, for example, 115-8. Similarly, the calculated difference represented as, for example, ‘H’ – ‘L’, corresponds to a positive value when the first isolation barrier, for example, 115-7 is farther to the machine 110-1 in comparison to the second isolation barrier, for example, 115-8. In embodiments, the positive or negative value of the calculated difference is indicative of a position of the machine on either side of the first isolation barrier, for example, 115-7 and the second isolation barrier, for example, 115-8 respectively. For example, the negative value of the calculated difference is indicative of the machine 110-1 positioned closer to the first isolation barrier, for example, 115-7 in comparison to the second isolation barrier, for example, 115-8. Similarly, the positive value of the calculated difference is indicative of the machine 110-1 positioned closer to the second isolation barrier, for example, 115-8 in comparison to the first isolation barrier, for example, 115-7. In embodiments, when the monitored first distance ‘H’ by the machine monitoring module 550 is equal to or greater than zero, as shown in FIG. 7, the machine monitoring module 550 is configured to determine an incursion of the first isolation barrier, for example, 115-7 by the machine 110-1 traversing from the zone Z1 into the zone Z2. Similarly, when the monitored second distance ‘L’ by the machine monitoring module 550 is equal to or proximately above zero, as shown in FIG. 9, the machine monitoring module 550 is configured to determine the incursion of the second isolation barrier, for example, 115-8 by the machine 110-1 traversing from the zone Z1 into the zone Z2. In embodiments, when the monitored first distance ‘H’ and the monitored second distance ‘L’ by the machine monitoring module 550 is equal or substantially equal, as shown in FIG. 8, the machine monitoring module 550 is configured to determine the location of the machine in the entry or the entry zone ‘E’. Further, the monitored second distance ‘L’ measured subsequent to the monitored second distance ‘L’ being equal to zero, as shown in FIG. 10, corresponds to an exit distance determined by the machine monitoring module 550.

In embodiments, the machine monitoring module 550 is configured to provide machine data including, but not limited to, the monitored distance, for example, the monitored first distance ‘H’, the monitored second distance ‘L’, the calculated difference, for example, ‘H’ – ‘L’, to the at least one controller, for example, 120. In embodiments, the machine monitoring module 550 is configured to provide the monitored entry distance to the at least one controller, for example, 120 prior to the entry into the isolation barrier, for example, 115-7 and provide and monitored exit distance to the at least one controller, for example, 120 after the exit from the isolation barrier, for example, 115-8 respectively. In embodiments, the machine monitoring module 550 is also configured to determine a position, a location, and/or an orientation of the machine 110-1 within the worksite 100, in the zones, for example, Z1 through Z3 (see FIGS. 2-4), and/or in proximity to the zones, for example, Z1 through Z3 within the worksite 100 based in the monitored first distance ‘H’, the monitored second distance ‘L’, the calculated difference, for example, ‘H’ – ‘L’, the unique machine identifier, and/or the unique barrier identifier associated with each isolation barrier, for example, 115-7, 115-8. For example, the machine monitoring module 550 is configured to determine the entry of the machine 110-1 from zone Z1 to the zone Z2 and in a direction moving away from the isolation barrier, for example, 115-8 and approaching the isolation barriers, for example, 115-9, 115-10 (see FIGS. 2-4) provided at the exit or the exit zone ‘X’ (see FIGS. 2-4) based on the machine data. In embodiments, the machine monitoring module 550 is also configured to provide the determined position, location, and/or orientation of the machine 110-1 within the worksite 100, in the zones, for example, Z1 through Z3 (see FIGS. 2-4), and/or in proximity to the zones, for example, Z1 through Z3 within the worksite 100 to the at least one controller, for example, 120 via the network 125.

In embodiments, the machine monitoring module 550 is also configured to perform at least one action based on at least one input received from the at least once controller, for example, 120 in response to the provided machine data and/or the determine position, location, and/or orientation of the machine 110-1. Examples of the at least one action include, but are not limited to, continuing the movement, slowing down, halting, and/or shutting down of the at least one machine 110-1. It will be understood by those with ordinary skill in the art the machine monitoring module 550 is configurable to communicate with one or more ECMs and/or one or more machine components including, but not limited to, machine transmission (not shown) and machine ignition (not shown) of the machine 110-1 to perform the at least one action including, but not limited to, the continuing of the movement, the slowing down, the halting, and/or the shutting down of the machine 110-1 in response to the at least one input received from the at least once controller, for example, 120. In embodiments, the machine monitoring module 550 is also configured to detect an obstruction or an object, via the machine input device 535, excluding the isolation barriers, for example, 115-9, 115-10 along the direction of the movement of the machine 110-1 and is configured perform the at least one action of slowing down, halting, and/or shutting down the machine 110-1 based on the detection and the machine data.

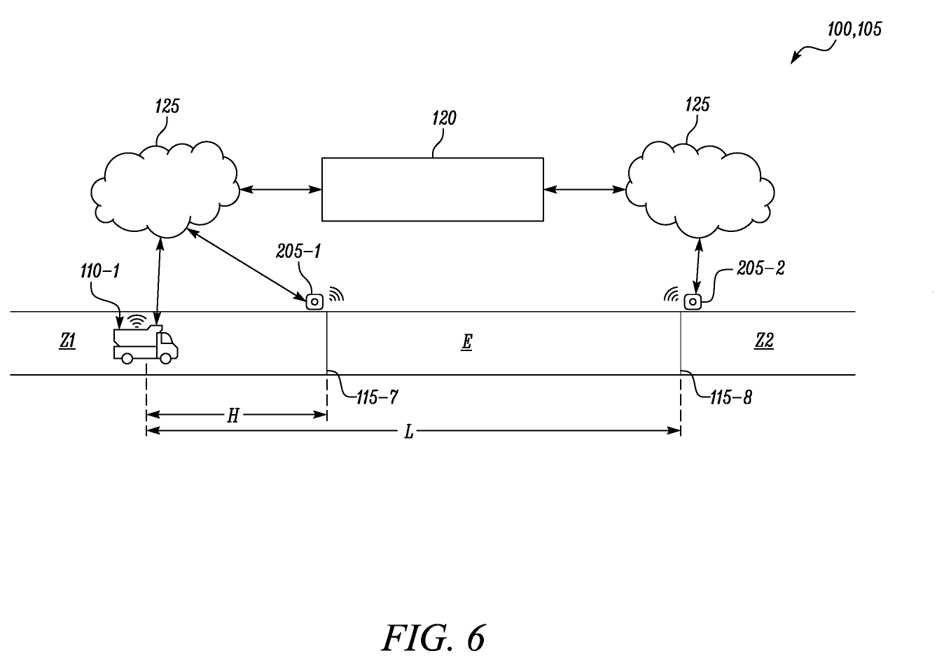

It will be understood by those with ordinary skill in the art, that the machine monitoring module 550 is also configured to detect the isolation barriers, for example, 115-9, 115-10, provided at the exit or the exit zone ‘X’ of the zone Z2, when the machine transceiver 545 is within a network range of the network 125, for example the RF network provided by the isolation barriers, for example, 115-9, 115-10 and the machine transceiver 545 receives signals, for example, but not limited to, RF signals from the isolation barriers, for example, 115-9, 115-10. In embodiments, the machine monitoring module 550 is also configured determine the unique barrier identifier associated with each isolation barrier, for example, 115-9, 115-10 and the store the determine unique barrier identifier in the machine storage unit 525 based on the received signals. In embodiments, upon receiving and/or storing the unique barrier identifier received from the isolation barrier, for example, 115-9, 115-10 respectively and prior to the exit from the zone Z2 and entry into the zone Z3 (see FIGS. 2-4), the machine monitoring module 550 is also configured to transmit the first signal(s) including the unique barrier identifier(s) to the at least one controller, for example, 120. In embodiments, the machine monitoring module 550 is also configured to transmit the signals, for example, but not limited to, the RF signals to the isolation barriers, for example, 115-9, 115-10 and/or the at least one barrier controller, for example, 205-3, 205-4 (see FIGS. 2-4). In embodiments, the machine monitoring module 550 is configured to transmit the second signal(s) including the unique machine identifier to the isolation barriers, for example, 115-9, 115-10 and/or the at least one barrier controller, for example, 205-3, 205-4. In embodiments, the machine monitoring module 550 is also configured to transmit the second signal(s) including the unique machine identifier to the at least one controller, for example, 120 via the network 125. In embodiments, the machine monitoring module 550 is also configured to transmit the second signal(s) to the at least one controller, for example, 120 upon detection of the isolation barriers, for example, 115-9, 115-10 and prior to the exit from the zone Z2 and the entry into the zone Z3. In embodiments, the machine monitoring module 550 is configured to transmit the third signal(s) to monitor a distance of the machine 110-1 from the isolation barriers, for example, 115-9, 115-10 and/or the at least one barrier controller, for example, 205-3, 205-4 via the machine processor 510 based on RF ranging. In embodiments, the machine monitoring module 550 is configured to monitor, via the machine processor 510, the distance of the machine 110-1 from the at least two isolation barriers, for example, 115-9, 115-10, calculate the difference between the monitored distances as outlined in the preceding paragraphs in the present disclosure with reference to FIGS. 5-6, and provide the machine data including, but not limited to, the monitored distances and/or the calculated difference to the at least one controller, for example, 120.

In embodiments, the machine monitoring module 550 is also configured to perform the at least one action including, but not limited to, the continuing of the movement, the slowing down, the halting, and/or the shutting down of the machine 110-1 prior to or after the machine 110-1 having exited from the zone Z2 and entered the zone Z3 independently or based on the at least one input received from the at least one controller, for example, 120 in response to the provided machine data. In embodiments, the machine monitoring module 550 is also configured to determine the position, location, and/or orientation of the machine 110-1 within the worksite 100, in the zones, for example, Z2 or Z3 (see FIGS. 2-4), and/or in proximity to the zone(s), for example, Z3 within the worksite 100. For example, the machine monitoring module 550 is configured to determine the exit of the machine 110-1 from the zone Z2 and the entry of the machine 110-1 into the zone Z3 and in a direction moving away from the isolation barrier, for example, 115-10 provided at the exit or the exit zone ‘X’ (see FIGS. 2-4) of the zone Z2 based on the machine data. In embodiments, the machine monitoring module 550 is configured to provide the determined position, location, and/or orientation of the machine 110-1 within the worksite 100 to the at least one controller, for example, 120.

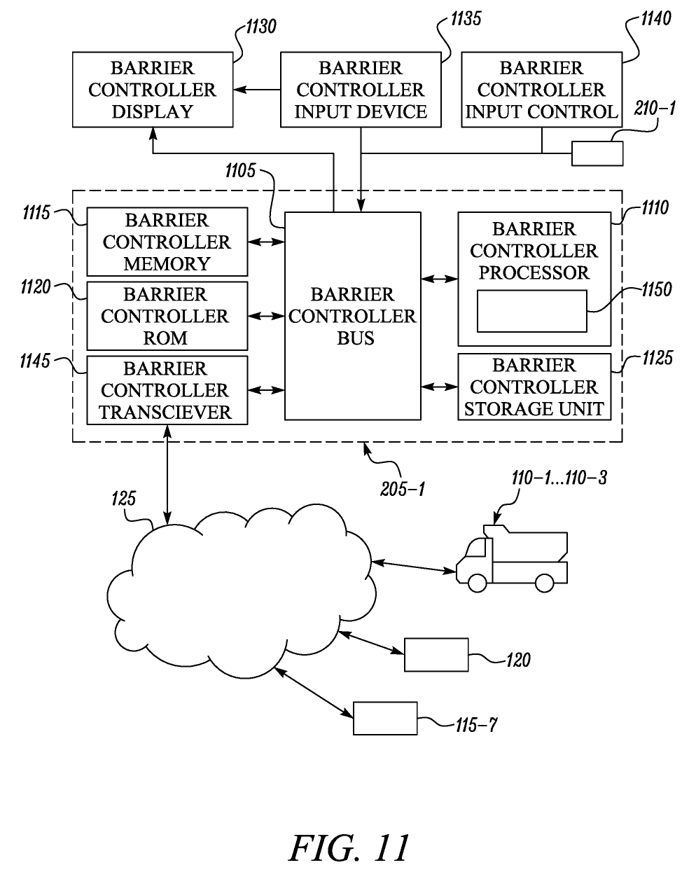

Referring to FIG. 11, a schematic block diagram of the barrier controller, for example, 205-1, in communication with the isolation barrier, for example, 115-7 provided at the entry, for example, ‘E’ (see FIGS. 6-10) of the zone, for example, Z2 (see FIGS. 6-10), the at least one machine, for example, 110-1 of FIG. 5, and the at least one controller, for example, 120 via the network 125. It will be apparent to those with ordinary skill in the art that the other barrier controllers, for example, 205-2 through 205-4 associated with corresponding isolation barriers, for example, 115-8 through 115-10 are also configured to include similar components and perform similar functions as the barrier controller 205-1. In embodiments, the barrier controller 205-1 is configured to include barrier controller components, for example, 1105 through 1145 similar to the machine components, for example, 505 through 545 of the machine control system 500 included in the machine 110-1 of FIG. 5. In embodiments, the barrier controller components, for example, 1105 through 1145 are also configured to perform similar functions as the machine components, for example, 505 through 545. For example, barrier controller 205-1 includes a barrier controller bus 1105, a barrier controller processor 1110, a barrier controller memory 1115, a barrier controller ROM 1120, a barrier controller storage unit 1125, a barrier controller display 1130, a barrier controller input device 1135, a barrier controller input control 1140, and a barrier controller transceiver 1145. In embodiments, the barrier controller storage unit 1125 is configured to store information including, but are not limited to, the unique machine identifier associated with the at least one machine, for example, 110-1 through 110-3, the unique barrier identifier associated with the isolation barrier, for example, 115-7, the distance of the at least one machine, for example, 110-1 through 110-3 from the isolation barrier, for example, 115-7, and/or a position, location, and/or an orientation of the machine 110-1 with respect to the isolation barrier, for example, 115-7. In embodiments, barrier controller 205-1 is also configured to include one or more output devices including, but not limited to, the one or more barrier state visual indicators, for example, 210-1 (also see FIGS. 2-4) to indicate the barrier state of the isolation barrier, for example, 115-7. In embodiments, the barrier state of the isolation barrier, for example, 115-7 is indicative of the presence or the absence, the placing or the removal, the activation or the deactivation, or the incursion of the isolation barrier, for example, 115-7. In embodiments, the barrier state visual indicator(s), for example, 210-1 is configured to display one or more colors to display the barrier state. In embodiments, the barrier state visual indicator(s), for example, 210-1 is configured to display different colors to indicate the different barrier states of the isolation barrier, for example, 115-7.

In embodiments, the barrier controller processor 1110 may include one or more modules to perform one or more functions. For example, the barrier controller processor 1110 may include a barrier monitoring module 1150. In embodiments, the module(s), for example, 1150 may correspond to and/or include hardware and/or software components and may be configured to perform respective functions. In embodiments, the barrier monitoring module 1150 is configured to transmit one or more signals, for example, the RF signals, via the barrier controller transceiver 1145, to provide the network 125 and enable the at least one machine, for example, 110-1 to establish communication with the barrier controller 205-1 via the network 125 provided by the barrier monitoring module 1150. In embodiments, the barrier monitoring module 1150 is also configured to transmit the signal(s) including, but not limited to, the unique barrier identifier associated with the isolation barrier, for example, 115-7. In embodiments, the barrier monitoring module 1150 is also configured to transmit the signal(s) to determine the distance of the at least one machine, for example, 110-1 from the isolation barrier, for example, 115-7 based on the RF ranging. In embodiments, the barrier monitoring module 1150 is also configured to receive the signal(s) including, but not limited to, the unique machine identifier associated with the at least one machine, for example, 110-1, via the barrier controller transceiver 1145, when the at least one machine, for example, 110-1 is within the network range of the network 125 provided by the barrier monitoring module 1150. In embodiments, the barrier monitoring module 1150 is also configured to determine the position of the at least one machine, for example, 110-1 on either side of the isolation barrier, for example, 115-7 based on the received signal(s) from the at least one machine, for example, 110-1. In embodiments, the barrier monitoring module 1150 is configured to provide the unique barrier identifier associated with the isolation barrier, for example, 115-7, the unique machine identifier associated with the at least one machine, for example, 110-1, the determined distance of the at least one machine, for example, 110-1 from the isolation barrier, for example, 115-7, and the determine position of the at least one machine, for example, 110-1 on either side of the isolation barrier, for example, 115-7 to the at least one controller, for example, 120.

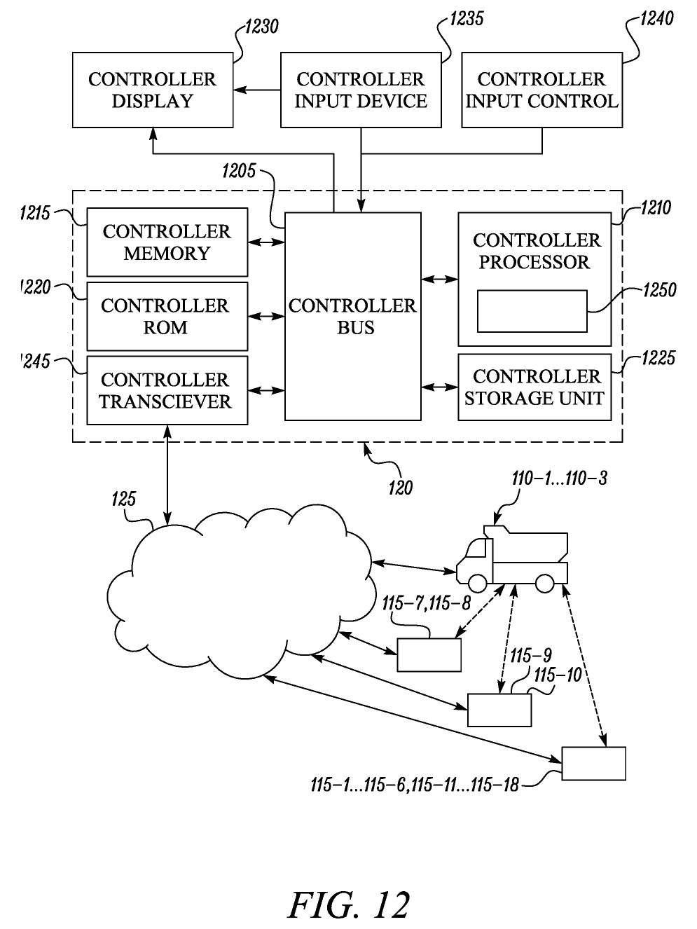

Referring to FIG. 12, a schematic block diagram of the at least one controller, for example, 120, herein referred to as the ‘controller 120’ in communication with the isolation barriers, for example, 115-1 through 115-18 provided at the entry, for example, ‘E’ (see FIGS. 2-4) and/or the exit, for example, ‘X’ (see FIGS. 2-4) of the zones, for example, Z1 through Z4 (see FIG. 1) and the at least one machine, for example, 110-1 through 110-3 of FIG. 5. In embodiments, the controller 120 is configured to include controller components, for example, 1205 through 1245 similar to the machine components, for example, 505 through 545 of the machine control system 500 included in the machine 110-1 of FIG. 5 respectively. In embodiments, the controller components, for example, 1205 through 1245 are also configured to perform similar functions as the machine components, for example, 505 through 545 respectively. For example, controller 120 includes a controller bus 1205, a controller processor 1210, a controller memory 1215, a controller ROM 1220, a controller storage unit 1225, a controller display 1230, the controller input device 1235, the controller input control 1240, and the controller transceiver 1245. In embodiments, the controller storage unit 1225 is configured to store information including, but are not limited to, the unique barrier identifier associated with the isolation barriers, for example, 115-7, 115-8, 115-9, 115-10 (see FIGS. 2-4) or the barrier controllers, for example, 205-1 through 205-4 (see FIG. 2) respectively, the unique machine identifier associated with the at least one machine, for example, 110-1 through 110-3 respectively, the distance of the at least one machine, for example 110-1 from the isolation barriers, for example, 115-7, 115-8, the difference in the distance of the at least one machine, for example, 110-1 from the isolation barriers, for example, 115-7, 115-8, the geographic route map of the worksite 100 including, but not limited to, the geographic locations of the predefined zones, for example Z1 through Z4 within the worksite 100, the barrier state associated with the isolation barriers, for example, 115-7, 115-8, and/or the position, location, and/or an orientation of the machine 110-1 within the worksite 100.

In embodiments, the controller processor 1210 may include one or more modules to perform the one or more functions. For example, the controller processor 1210 may include a controller monitoring module 1250. It may be understood that the module(s), for example, 1250 may correspond to and/or include hardware and/or software components respectively and may be configured to perform respective functions. In embodiments, the controller monitoring module 1250 is configured to operate the isolation barriers, for example, 115-1 through 115-8 provided in the predefined zones, for example, Z1 through Z4. For example, the controller monitoring module 1250 is configured to activate or deactivate, or place or remove the isolation barriers, for example, the first isolation barrier, for example, 115-7 and the second isolation barrier, for example, 115-8 provided at the entry ‘E’ of the zone, for example, Z2. In embodiments, the controller monitoring module 1250 is also configured to monitor the barrier state of the isolation barriers, for example, 115-1 through 115-18 (see FIG. 1). For example, the controller monitoring module 1250 is configured to monitor the barrier state associated with the first barrier, for example, 115-7 and/or the second barrier, for example, 115-8 provided at the entry “E” (see FIGS. 6-10) of the zone, for example, Z2. In embodiments, the controller monitoring module 1250 is configured to receive the barrier state associated with the isolation barriers, for example, 115-1 through 115-18 via the at least one barrier controller, for example, 205-1 through 205-4 associated with the isolation barriers, for example, 115-1 through 115-18 respectively. In embodiments, the controller monitoring module 1250 is also configured to determine the incursion of the first barrier, for example, 115-7 and/or the second barrier, for example, 115-8, and/or an order of the incursion of the first barrier, for example, 115-7 and the second barrier, for example, 115-8 by the at least one machine, for example, 110-1 based on the monitored barrier state, the unique barrier identifier of the isolation barriers, for example, 115-7, 115-8 associated with incursion, and unique machine identifier of the at least one machine, for example, 110-1 associated with incursion. In embodiments, the controller 120 is configured to receive the unique barrier identifier from the isolation barriers, for example, 115-7, 115-8 and the unique machine identifier of the at least one machine, for example, 110-1 prior to the entry, during the movement, prior to the exit, and/or after the exit of the at least one machine, for example, 110-1 from one zone to another zone of the predefined zones, for example, Z1 through Z4 (see FIG. 1) within the worksite 100 (see FIG. 1).

In embodiments, the controller 120 is also configured to receive the distance of the at least one machine, for example, 110-1 from the at least two isolation barriers, for example, 115-7, 115-8 via the machine transceiver 545 (see FIG. 5) of the at least one machine, for example, 110-1. In embodiments, the controller 120 is also configured to calculate the difference in the received distance of the at least one machine, for example, 110-1 from the at least two isolation barriers, for example, 115-7, 115-8. For example, the controller 120 is configured to receive the first distance ‘H’ (see FIGS. 6-10) of the at least one machine, for example, 110-1 from the first isolation barrier, for example, 115-7 and the second distance ‘L’ (see FIGS. 6-10) of the at least one machine, for example, 110-1 from the second isolation barrier, for example, 115-8 from the machine transceiver 545 prior to the entry of the at least one machine, for example, 110-1 into the zone, for example, Z2. The controller 120 is configured to then calculate the difference between the first distance ‘H’ and the second distance ‘L’ received from the at least one machine, for example, 110-1. In embodiments, the controller 120 is also configured to receive the calculated difference, for example, ‘H’ – ‘L’ directly from the at least one machine, for example, 110-1 via the machine transceiver 545. In embodiments, the controller 120 is configured to correlate the monitored incursion or the monitored order of the incursion with the calculated difference and/or the monitored distances, for example, the monitored first distance and the monitored second distance, received from the at least one machine. In embodiments, the controller 120 is configured to determine the position, the location, and/or the orientation of the at least one machine, for example, 110-1 within or outside of the at least one zone, for example, Z1 through Z4 based on the correlation. In embodiments, the controller 120 is also configured to determine the position, the location, and/or the orientation of the at least one machine, for example, 110-1 through 110-3 traversing across the predefined zones, for example, Z1 through Z4 based on the monitored incursion and/or the monitored order of the incursion of the isolation barriers, for example, 115-1 through 115-18 provided at the entry and/or exit of the predefined zones, for example, Z1 through Z4, the monitored distances of the at least one machine, for example, 110-1 through 110-3 from the isolation barriers, for example, 115-1 through 115-18 and/or the determined correlation between the monitored distances and the determined incursion or the order of incursion in each zone of the predefined zones, for example, Z1 through Z4. For example, the controller monitoring module 1250 is configured to determine the entry of the machine 110-1 from zone Z1 to the zone Z2 and in a direction moving away from the isolation barrier, for example, 115-8 provided at the entry ‘E’ (see FIGS. 2-4) of the zone Z2 and approaching the isolation barriers, for example, 115-9, 115-10 (see FIGS. 2-4) provided at the exit or the exit zone ‘X’ (see FIGS. 2-4) of the zone Z2 based on the determined correlation.

In embodiments, the controller 120 is configured to perform the at least one action including, but not limited to, allowing the movement, slowing down, halting, and/or shutting down of the at least one machine, for example, 110-1 in or in proximity to the predefined zones, for example, Z1 through Z4 based on the determined correlation and the determined location. In embodiments, the controller 120 is configured to provide instructions to the at least one machine, for example, 110-1 to perform the at least one action and the at least one machine, for example, 110-1 is configured to perform the at least one action based on the received instructions from the controller 120.

In embodiments, the controller 120 is also configured to detect and determine the incursion of the isolation barriers, for example, 115-7, 115-8, 115-9, 115-10 associated with the entry ‘E and/or the exit ‘X’ of the at least one zone, for example, zone Z2 by an object (not shown) different from the at least one machine, for example, 110-1 based on monitored barrier state of the isolation barriers, for example, 115-7, 115-8, 115-9, 115-10. Examples of the object include, but are not limited to, one or more human operators or personnel, one or more machines, for example, 110-2, 110-3, or one or more robots or robotic devices (not shown) employed within the worksite 100. In embodiments, the controller 120 is configured to determine a unique object identifier of the object associated with the incursion. In embodiments, the controller 120 is configured to determine the unique object identifier based on an electronic device (not shown) associated with the object. Examples of the electronic device include, but are not limited to, a smartphone, a smartwatch, an electronic tag, or any other communication device now known or in the future developed that is capable of communicating with the controller 120. In embodiments, the controller 120 is configured to determine the incursion and determine the unique object identifier associated with object via the at least one barrier controller, for example, 205-1 through 205-4. For example, the at least one barrier controller, for example, 205-4 is configured to monitor the barrier state of the isolation barriers, for example, 115-7, 115-8, 115-9 and determine the incursion of one or more isolation barriers, for example, 115-9, 115-10 by the object. The at least one barrier controller, for example, 205-4 is configured to transmit and/or receive signals, for example, RF signals to or from the object to determine the unique object identifier associated with the object. The at least one barrier controller, for example, 205-4 is configured to provide the determined unique object identifier to the controller 120. In embodiments, the controller 120 is configured to determine the unique object identifier associated with the object prior to the entry and/or after the exit of the object into or outside the at least one zone, for example, zone Z2. For example, the controller 120 is configured to determine the movement and a direction of the movement of the object towards the isolation barriers, for example, 115-7, 115-8, 115-9, 115-10 provided at the entry ‘E’ or the exit ‘X’ of the zone, for example, Z2 based on at least one input received from the object. Examples of the at least one input include, but are not limited to, the distance of the object from the isolation barriers, for example, 115-10, 115-9 respectively and the calculated difference of the distances from the isolation barriers, for example, 115-10, 115-9 prior to the entry of the object into the zone, for example, Z2. In embodiments, the controller 120 is configured to determine a location of the object on either side of the isolation barriers, for example, 115-7, 115-8, 115-9, 115-10 based on determined distances and/or the calculated difference. In embodiments, for instances when the controller 120 and/or the at least one barrier controller, for example, 205-4 is unable to determine the unique object identifier associated with object, for example, when the object is devoid of the associated electronic device, the controller 120 is configured to assign the unique object identifier associated with the object as indeterminate or null.

In embodiments, the controller 120 is configured to perform the at least one action including, but not limited to, allowing the movement, slowing down, halting, and/or shutting down of the at least one machine, for example, 110-1 and/or the object when the determined incursion by the at least one machine, for example, 110-1 and the determined incursion by the object is within a predefined time period and/or when the received unique object identifier is indeterminate/null or different from the received unique machine identifier of the at least one machine, for example, 110-1 corresponding to isolation barriers, 115-7, 115-8, 115-9, 115-10 associated with the at least one zone, for example, Z2. In embodiments, the controller 120 is also configured to perform the at least one action when the determined position, location, and/or orientation of the at least one machine, for example, 110-1 is different from the position, location, and/or orientation of the at least one machine, for example, 110-1 within a zone, for example, Z2. For example, the controller 120 is configured to perform the at least one action of slowing down, halting, and/or shutting down the at least one machine 110-1 and/or the object when the determined position, location, and/or orientation of the at least one machine, for example, 110-1 is opposite to the determined position, location, and/or orientation of the object in the zone, for example, Z2. As another example, the controller 120 is configured to determine the movement of the machine 110-1 from the zone Z1 to the zone Z2 based on the monitored distances, the calculated difference in the monitored distances of the machine 110-1 from the isolation barriers 115-7, 115-8 and determined incursion of the isolation barriers 115-7, 115-8 provided the entry ‘E’ of the zone Z2. Similarly, the controller 120 is configured to determine the movement of the object from the zone Z3 to the zone Z2 based on the monitored distances, the calculated difference in the monitored distances of the object from the isolation barriers 115-9, 115-10 and determined incursion of the isolation barriers 115-9, 115-10 provided the exit ‘X’ of the zone Z2. The controller 120 is then configured to perform the at least one action of slowing down, halting, and/or shutting down the machine 110-1 and/or the object based on the determine position, location, and/or orientation of the machine 110-1 and the object in the zone Z2. Conversely, the controller 120 is configured to perform the at least one action of allowing the continued movement of the at least one machine 110-1 and/or the object when the determined position, location, and/or orientation of the at least one machine, for example, 110-1 is same as the determined position, location, and/or orientation of the object in the zone, for example, Z2 or when both the at least one machine, for example, 110-1 and the object are assigned to the same zone, for example, Z2. As an example, the controller 120 is configured to perform the at least one action of allowing the machine 110-1 and the object to continue movement when the both the machine 110-1 and the object are moving in the same direction, for example, when the machine 110-1 is moving into the zone Z2 and the object is moving to the zone Z3 from the zone Z2.

### INDUSTRIAL APPLICABILITY

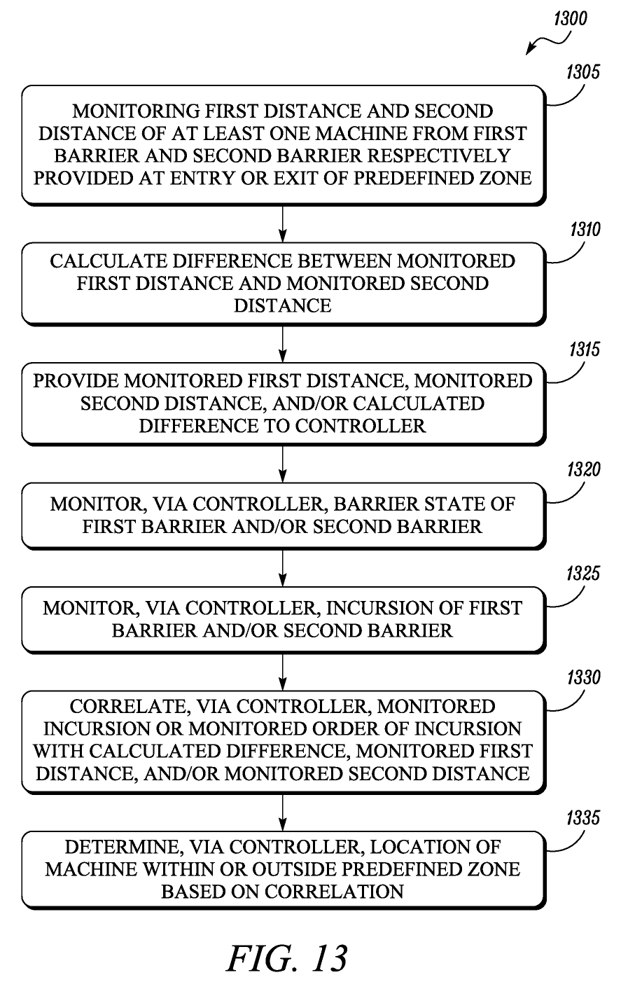

Referring to FIG. 13, an exemplary method 1300 for tracking the movement of the at least one machine, for example, 110-1 of FIG. 5 between the predefined zones, for example, Z1 through Z4 (see FIG. 1) within the worksite 100 (see FIG. 1). At step 1305, the at least one machine, for example, 110-1 is configured to monitor, via the machine processor 510 (see FIG. 5) of the at least one machine and the at least one controller, for example, 120, the first distance ‘H’ (see FIGS. 6-10) and the second distance ‘L’ (see FIGS. 6-10) of the at least one machine from the first isolation barrier, for example, 115-7 (see FIGS. 6-10) and the second isolation barrier, for example, 115-8 (see FIGS. 6-10) respectively provided at the entry ‘E’ (see FIGS. 2-4) or the exit ‘X’ (see FIGS. 2-4) of the at least one zone, for example, Z2. At step 1310, the at least one machine, for example, 110-1 is also configured to calculate, via the machine processor 510, the difference between the monitored first distance ‘H’ and the monitored second distance ‘L’. Further, at step 1315, the at least one machine, for example, 110-1 is also configured to provide, via the machine processor 510, the monitored first distance ‘H’, the monitored second distance ‘L’, and/or the calculated difference, for example, ‘H’ – ‘L’ to the at least one controller, for example, 120. At step 1320, the at least one controller, for example, 120 is configured to monitor a barrier state of the first isolation barrier, for example, 115-7 and the second isolation barrier, for example, 115-8 respectively. The barrier state is indicative of an activation or a deactivation, presence or absence, placing or removing, or incursion of the first isolation barrier, for example, 115-7 and the second isolation barrier, for example, 115-8 respectively. At step 1325, the at least one controller, for example, 120 is also configured to determine the incursion by the first isolation barrier, for example, 115-7 and the second isolation barrier, for example, 115-8 respectively, and/or an order of the incursion based on the monitored barrier state. Further, at step 1330, the at least one controller, for example, 120 is configured to correlate the monitored incursion and/or the monitored order of the incursion with the calculated difference, for example, ‘H’ – ‘L’, the monitored first distance ‘H’, and/or the monitored second distance ‘L’ received from the at least one machine, for example, 110-1. In addition, at step 1335, the at least one controller, for example, 120 is configured to determine the position, location, and/or the orientation of the at least one machine, for example, 110-1 within or outside of the at least one zone, for example, Z2 based on the correlation.

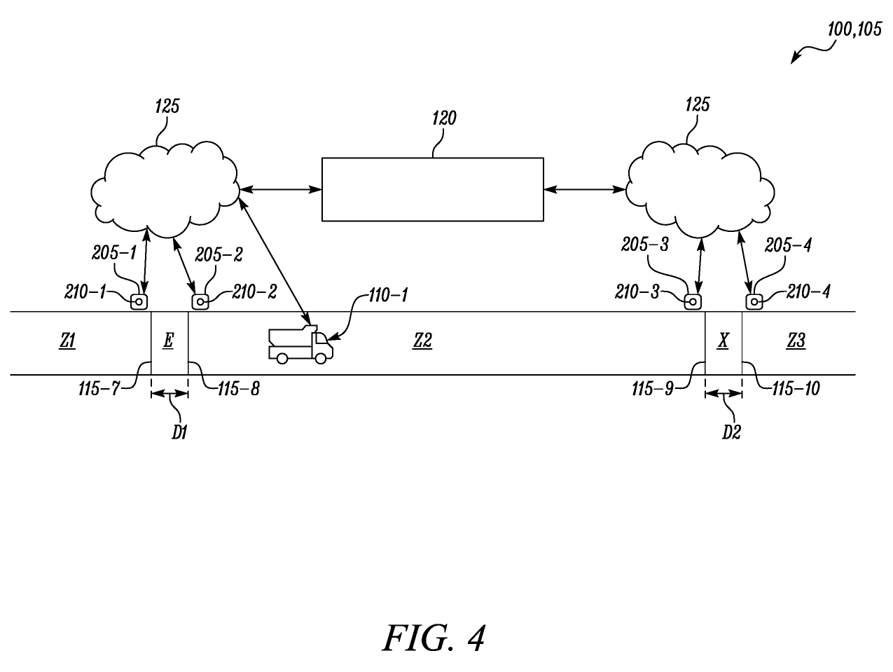

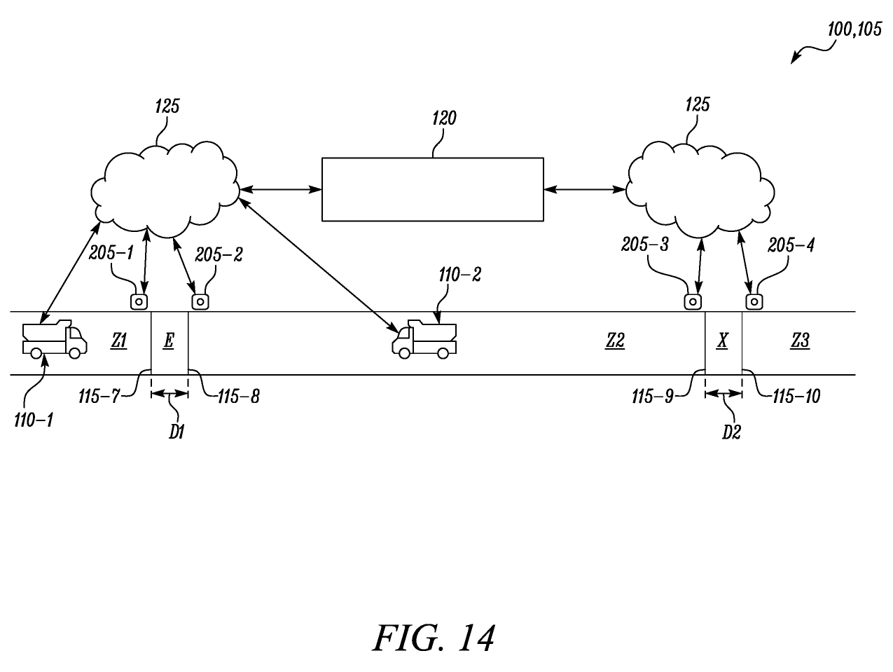

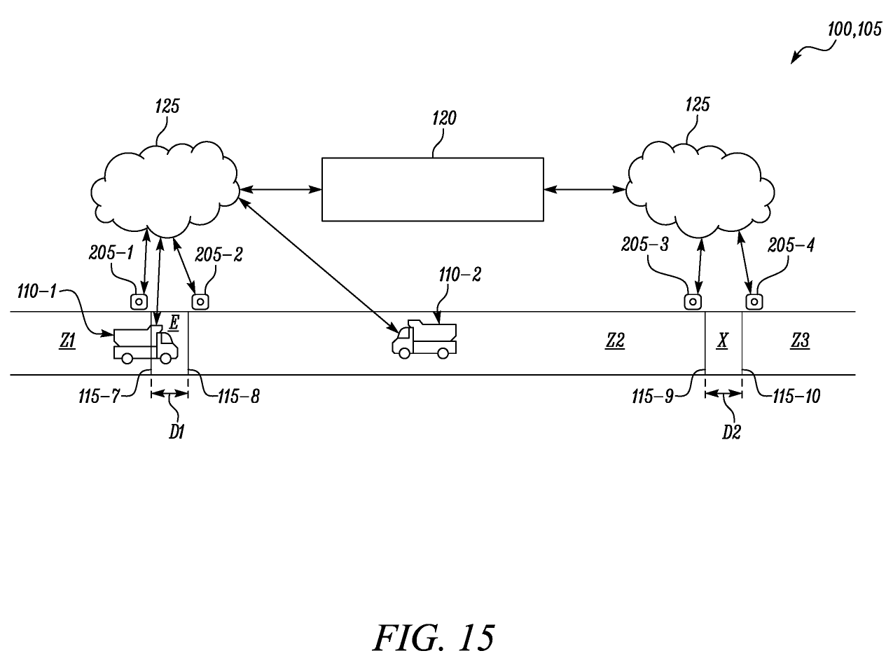

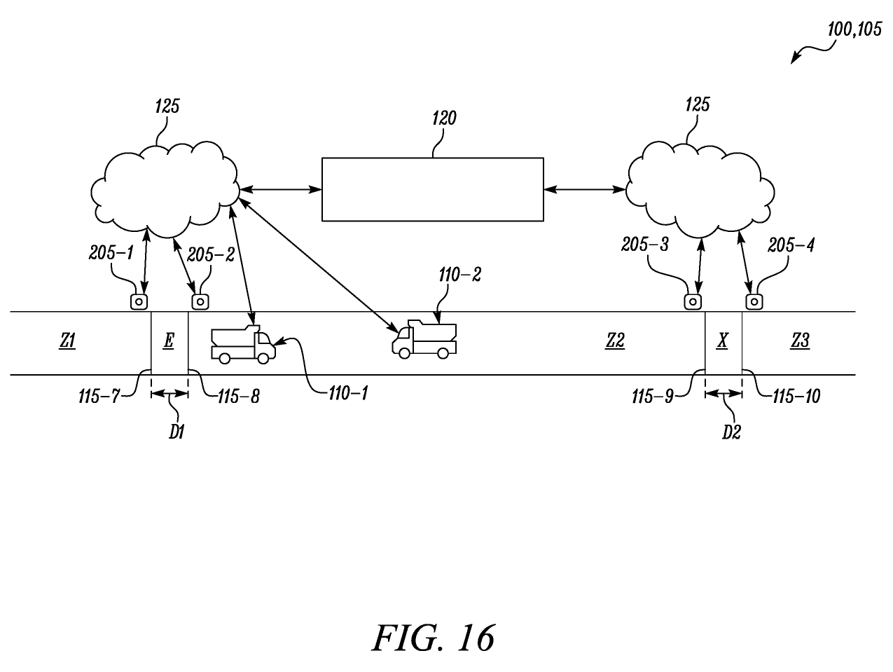

Referring to FIGS. 14-16, exemplary illustrations of the machine 110-1 of FIG. 4 moving from the zone Z1 to the zone Z2 in which a second machine, for example, 110-2 is currently operating. In embodiments, the controller 120 is configured to determine that the machine 110-1 is moving from the zone Z1 to the zone Z2 based on the monitored distances of the machine 110-1 from the isolation barriers, for example, 115-7, 115-8 provided at the entry ‘E’ of the zone Z2, the calculated difference, for example, ‘H’ – ‘L’ in the monitored distances, the determined incursion of the isolation barriers, for example, 115-7, 115-8 by the machine 110-1, the determined order of incursions of the isolation barriers, for example, 115-7, 115-8 by the machine 110-1, and/or the determined correlation between the determined incursion/order of incursions and the monitored distances and/or the calculated difference. In embodiments, the controller 120 is also configured to determine the second machine 110-2 within the zone Z2 based on the previous incursion of the second machine 110-2 into the zone Z2 or based on at least one input received from the second machine 110-2, for example, the distance of the second machine 110-2 from the isolation barriers, for example, 115-7, 115-8, the calculated difference, and/or based on the incursion of the isolation barrier(s), for example, 115-8 by the second machine 110-2 detected/determined by the controller 120. In embodiments, the controller 120 is configured to perform the action of slowing down, halting, and/or shutting down the machine 110-1 when the machine 110-1 is in the zone Z2 based on the monitored distances, the determined incursion, the determined order of incursion, the determined correlation and the determined position, location, and/or orientation of the machine 110-1 within the zone Z2.

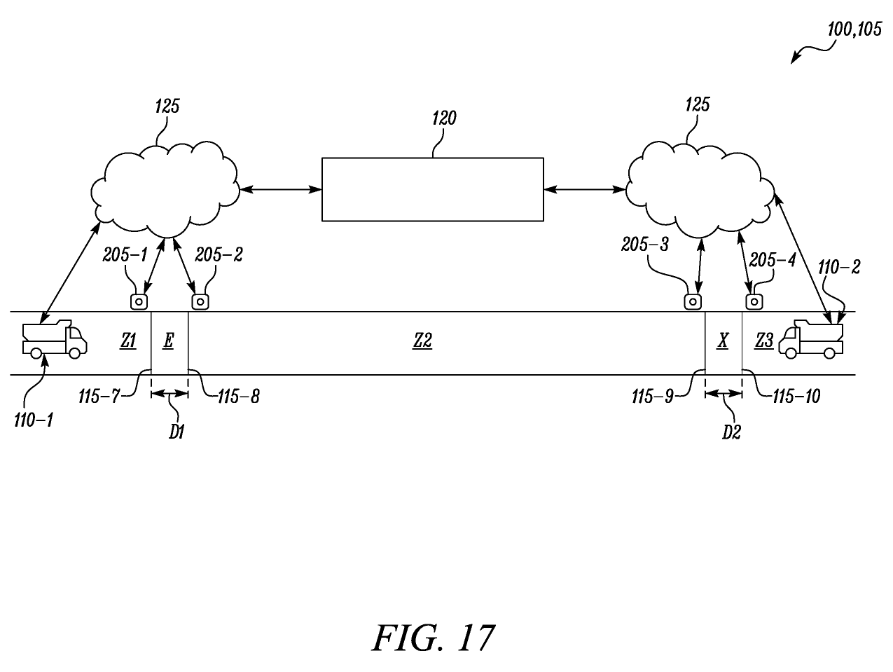

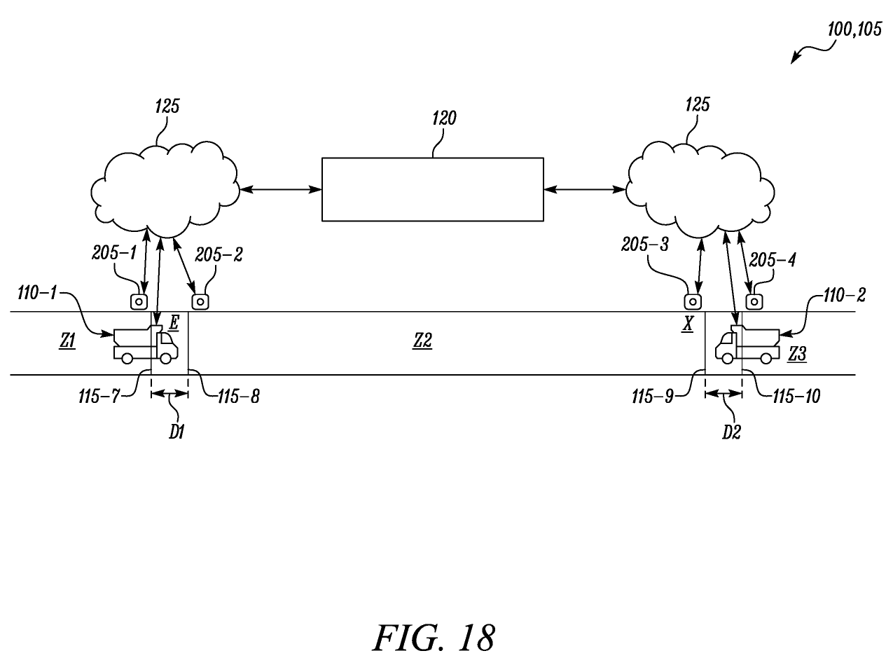

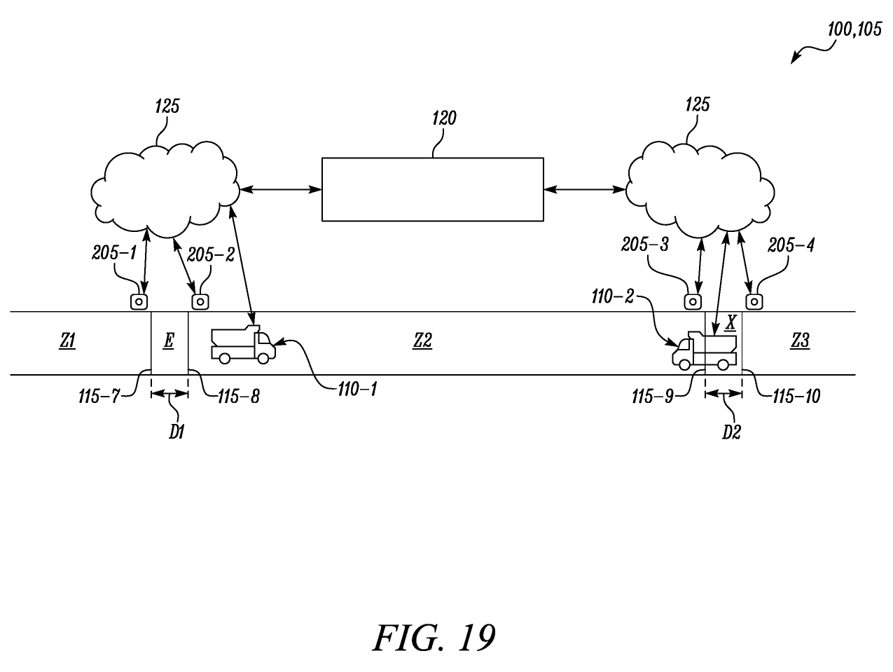

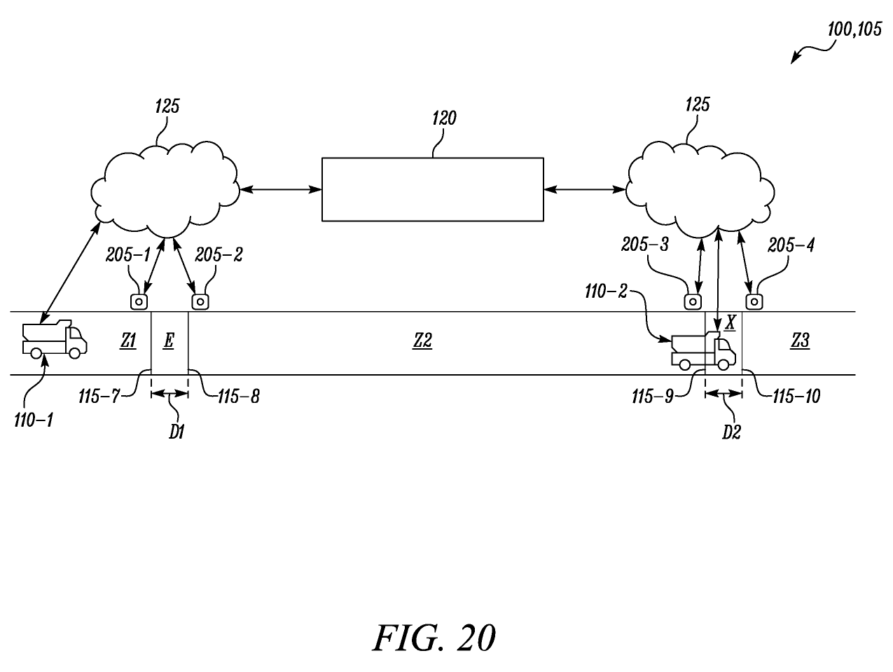

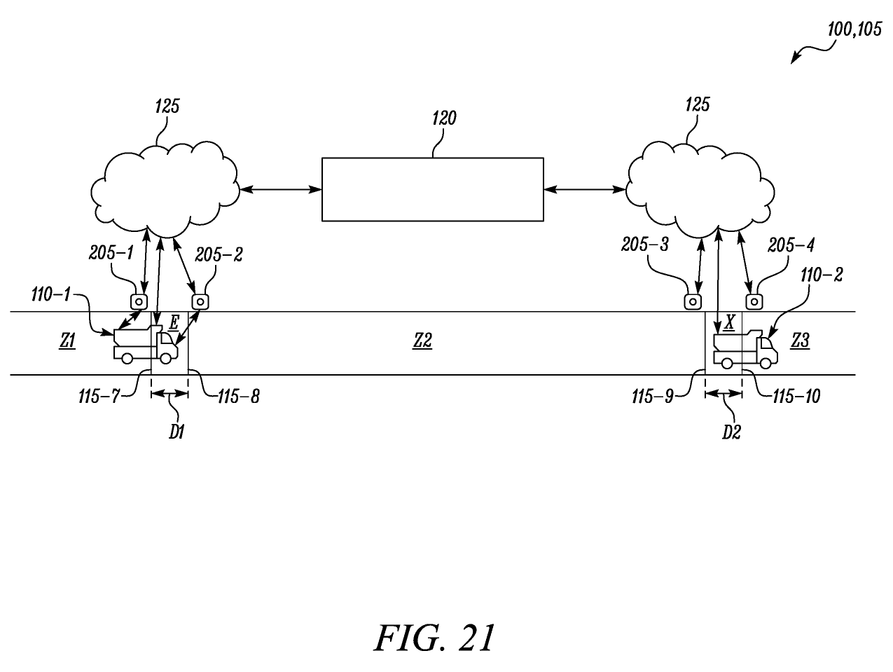

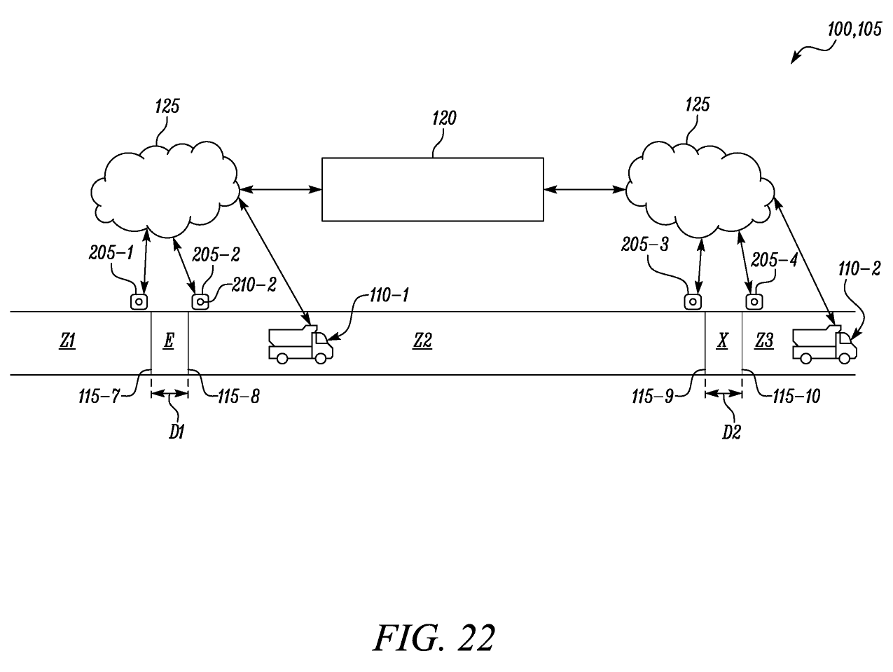

Referring to FIGS. 17-19, exemplary illustrations of two machines, for example, 110-1, 110-2 simultaneously entering the zone Z2 from opposite directions is disclosed. In embodiments, the controller 120 is configured to determine that the machine 110-1 is moving from the zone Z1 to the zone Z2 based on the monitored distances of the machine 110-1 from the isolation barriers, for example, 115-7, 115-8 provided at the entry ‘E’ of the zone Z2, the calculated difference in the monitored distances, the determined incursion of the isolation barriers, for example, 115-7, 115-8 by the machine 110-1, the determined order of incursions of the isolation barriers, for example, 115-7, 115-8 by the machine 110-1, and/or the determined correlation between the determined incursion and the monitored distances and/or the calculated difference. In embodiments, the controller 120 is configured to determine that the second machine 110-2 is moving from the zone Z3 to the zone Z2 based on the monitored distances of the second machine 110-2 from the isolation barriers, for example, 115-9, 115-10 provided at the exit ‘X’ of the zone Z2, the calculated difference in the monitored distances, the determined incursion of the isolation barriers, for example, 115-9, 115-10 by the machine 110-2, the determined order of the incursions, and/or the determined correlation between the determined incursion/order of incursion and the monitored distances and/or the calculated difference. In embodiments, the controller 120 is configured to perform the action of slowing down, halting, and/or shutting down the machine 110-1 and the machine 110-2 when the machine 110-1 and the machine 110-2 are determined to have entered the zone Z2 based on the monitored distances, the determined incursion/order of incursions, the determined correlation and the determined position, location, and/or orientation of the machine 110-1 and the machine 110- 2 respectively within the zone Z2.

Referring to 20-22, exemplary illustrations of the machine 110-1 of FIG. 4 entering the zone Z2 and the second machine, for example, 110-2, previously operating in the zone Z2, exiting the zone Z2 simultaneously is disclosed. In embodiments, the controller 120 is configured to determine that the machine 110-1 is moving from the zone Z1 to the zone Z2 based on the monitored distances of the machine 110-1 from the isolation barriers, for example, 115-7, 115-8 provided at the entry ‘E’ of the zone Z2, the calculated difference in the monitored distances, the determined incursion and/or the order of incursions of the isolation barriers, for example, 115-7, 115-8 by the machine 110-1, and/or the determined correlation between the determined incursion/order of incursions and the monitored distances and/or the calculated difference. Similarly, the controller 120 is also configured to determine that the second machine 110-2, operating in the zone Z2, is moving from the zone Z2 to the zone Z3 based on the monitored distances of the second machine 110-2 from the isolation barriers, for example, 115-9, 115-10 provided at the exit ‘X’ of the zone Z2, the calculated difference in the monitored distances, the determined incursion and/or the order of incursions of the isolation barriers, for example, 115-9, 115-10 by the second machine 110-2, and/or the determined correlation between the determined incursion/order of incursions and the monitored distances and/or the calculated difference. In embodiments, the controller is configured to perform the action of allowing the movement of the machine 110-1 from the zone Z1 to Z2 and the movement of the machine 110-2 from the zone Z2 to Z3 based on the monitored distances, the determined incursion/order of incursions, the determined correlation and the determined position, location, and/or orientation of the machine 110-1 and the machine 110-2 respectively within the zone Z2.

It is apparent, in view of the above, that the system 105 including the at least one machine, for example, 110-1 through 110-3, the isolation barriers, for example, 115-1 through 115-18, and the at least one controller, for example, 120 and the method 1300 of the present disclosure, enable accurate and verifiable tracking of the at least one machine, for example, 110-1 through 110-3 within the worksite 100 and/or within or in proximity to the predefined zones, for example, Z1 through Z4. The system 105 and the method 1300 of the present disclosure enable the accurate and verifiable tracking of the at least one machine, for example, 110-1 by correlating at least one input received from the at least one machine, for example, 110-1 and the isolation barriers, for example, 115-7, 115-8 respectively. The at least one input received from the at least one machine, for example, 110-1 corresponds to the monitored distances of the at least one machine, for example, 110-1 from the isolation barriers, for example, 115-7, 115-8, determined based on, for example, the RF ranging by the at least one machine, for example, 110-1. The at least one input received from the isolation barriers, for example, 115-7, 115-8 corresponds to the determined incursion of the isolation barriers, for example, 115-1 through 115-18 by the at least one machine, for example, 110-1 in each zone, for example, Z2 within the worksite 100. Further, the system 105 and the method 1300 of the present disclosure also enable corrective actions including, but not limited to, slowing down, halting, and/or shutting down of the at least one machine, for example, 110-1, to be taken based on the determined position, location, and/or orientation of the at least one machine, for example, 110-1 and/or 110-2 with respect to the isolation barriers, for example, 115-7, 115-8 and/or within or in proximity to the at least one zone, for example, Z2 within the worksite 100. In addition, the system 105 and the method 1300 of the present disclosure ensure safety of personnel/operators and machines operating within the worksite 100 and traversing across the zones, for example, Z1 through Z4 by performing the corrective actions in a timely manner and thereby avoiding accidents involving human operators and/or the machines, for example, 110-1 through 110-3. Furthermore, the system 105 and the method 1300 of the present disclosure also enable the machines, for example, 110-1 through 110-3 to meet production requirements and safely move through the different zones, for example, Z1 through Z4 as a result of the tracking of the machines, 110-1 through 110-3 within the worksite 100 and/or the zones, for example, Z1 through Z4 and the corrective actions taken by the at least one controller, for example, 120, and/or the system 105.

Unless explicitly stated, the use of the singular to describe a component, structure, or operation does not exclude the use of plural such components, structures, or operations or their equivalents. The use of the terms “a” and “an” and “the” and “at least one” or the term “one or more,” and similar references herein are to be construed to cover both the singular and the plural, unless otherwise indicated herein. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; or A, B and B), unless otherwise indicated herein. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

1. A system for tracking a movement of at least one machine between predefined zones in a worksite, comprising:
a first barrier positioned at an entry or an exit of at least one zone of the predefined zones respectively;
a second barrier positioned at a predefined distance from the first barrier after the entry or the exit;
at least one controller associated with the first barrier and the second barrier; and
the at least one machine in communication with the at least one controller, wherein the at least one machine, assigned to move across the at least one zone, is configured to:
monitor, via a processor of the at least one machine and the at least one controller, a first distance and a second distance of the at least one machine from the first barrier and the second barrier respectively;
calculate, via the processor, a difference between the monitored first distance and the monitored second distance; and
provide, via the processor, at least one of the monitored first distance, the monitored second distance, or the calculated difference to the at least one controller,
and wherein the at least one controller is configured to:
monitor a barrier state of the first barrier, the second barrier, or both the first and the second barriers, wherein the barrier state is indicative of at least one of a presence, an absence, or an incursion of the first barrier, the second barrier, or both the first and the second barriers;
monitor at least one of the incursion of the first barrier, the second barrier, both the first barrier and the second barrier, or an order of the incursion of the first barrier and the second barrier by the at least one machine based on the monitored barrier state;
correlate the monitored incursion or the monitored order of the incursion with the calculated difference, the monitored first distance, the monitored second distance, or any combination thereof received from the at least one machine; and
determine at least one of a position, a location, or an orientation of the at least one machine within or outside of the at least one zone based on the correlation.

2. The system of claim 1, wherein the at least one controller is configured to operate the first barrier, the second barrier, or both the first barrier and the second barrier, wherein the first barrier, the second barrier, or both the first barrier and the second barrier correspond to at least one barricade or at least one light emitting device configured to provide a light screen as a barrier extending in a direction perpendicular to a direction of the movement of the at least one machine.

3. The system of claim 1, wherein the at least one machine is configured to provide a unique machine identifier to the at least one controller prior to the entry or the exit from or into the at least one zone, and wherein the at least one controller is configured to:
identify the at least one machine, the entry or the exit associated with the at least one zone, or both the at least one machine and the entry and the exit associated with at least one zone based on the unique machine identifier; and
monitor the barrier state associated with the first barrier, the second barrier, or both the first and the second barriers provided in the at least one zone based on the identification, wherein the at least one controller is configured to receive a unique barrier identifier associated with the first barrier, the second barrier, or both the first and the second barriers from the first barrier, the second barrier, or both the first and the second barriers based on the determined incursion of the first barrier, the second barrier, or both the first and the second barriers.

4. The system of claim 1, wherein the at least one machine is configured to monitor the first distance and the second distance based on radio frequency (RF) ranging with the at least one controller or the first barrier and the second barrier.

5. The system of claim 1, wherein the at least one controller is configured to:
determine the location of the machine traversing across the predefined zones based on at least one of the monitored incursion, the monitored order of the incursion, the monitored first distance, the monitored second distance, or the determined correlation in each zone of the predefined zones; and
perform at least one action based on the determined location.

6. The system of claim 5, wherein the at least one action corresponds to reducing a ground or engine speed of, halting, shutting down or allowing the at least one machine to pass across one or more zones of the predefined zones based on the determined location.

7. The system of claim 1, wherein the at least one controller is configured to:
detect the incursion of the first barrier or the second barrier associated with the entry or the exit of the at least one zone by an object different from the at least one machine;
determine a unique object identifier associated with the object associated with the incursion and a unique machine identifier of the at least once machine, wherein the object and the at least one machine are configured to provide the unique object identifier and the unique machine identifier to the at least one controller prior to the entry or the exit, or the unique object identifier associated with the object is indeterminate; and
perform at least one action when the determined unique object identifier is indeterminate or different from the determined unique machine identifier.

8. The system of claim 7, wherein the at least one controller is configured to:
determine a distance of the object from the first and the second barriers at the entry or the exit of the at least one zone respectively; and
determine at least one of a location, position, or an orientation of the object on either side of the first barrier, the second barrier, or both the first barrier and the second barrier based on the determined distance or a difference in the determined distance.

9. The system of claim 7, wherein the at least one action corresponds to halting or shutting down the at least one machine.

10. The system of claim 8, wherein the at least one action corresponds to:
halting or shutting down the at least one machine when the determined location or position of the object is proximate to the determined location of the machine;
allowing the at least one object, the at least one machine, or both the at least one object and the at least one machine to traverse across the at least one zone when the determine location or position of the object and the at least one machine based on the determined distance, the monitored first distance, and the monitored second distance indicates the movement of the object and the at least one machine in a same direction.

11. The system of claim 7, wherein the at least one action corresponds to:
providing the monitored barrier state indicative of the determined incursion by the object, the first unique identifier associated with the object, or both the monitored barrier state and the first unique identifier to the at least one machine; and
the at least one machine is configured to:
halt or shut down, via the processor of the machine, the at least one machine based on the monitored barrier state, the first unique identifier, or both the monitored barrier state and the first unique identifier.

12. A control system for tracking movement of at least one machine between predefined zones in a worksite, comprising:
a processor; and
a memory for storing instructions, that when executed by the processor, causes the processor to:
receive, via at least two barriers provided at an entry/exit of at least one zone of the predefined zones, a barrier state of the at least two barriers, wherein the barrier state is indicative of at least one of a presence, an absence, or an incursion of at least one of the at least two barriers;
determine the incursion of at least one of the at least two barriers, or an order of the incursion of the at least two barriers by the at least one machine based on the received barrier state;
receive, via the at least one machine, a distance of the at least one machine from the at least two barriers respectively;
calculate, via the processor, a difference between the received distance of the at least one machine from the at least two barriers respectively;
correlate the determined incursion or the determined order of the incursion with the calculated difference, the received distance, or any combination thereof; and
determine at least one of a position, a location, or an orientation of the at least one machine within or outside of the at least one zone based on the correlation.

13. A method for tracking movement of at least one machine between predefined zones in a worksite, comprising:
monitoring, via a processor of the at least one machine and at least one controller associated with a first barrier and a second barrier provided at an entry or an exit of at least one zone of the predefined zones respectively, a first distance and a second distance of the at least one machine from the first barrier and the second barrier respectively;
calculating, via the processor, a difference between the monitored first distance and the monitored second distance; and
provide, via the processor, at least one of the monitored first distance, the monitored second distance, or the calculated difference to the at least one controller,
monitoring, via the at least one controller, a barrier state of the first barrier, the second barrier, or both the first and the second barriers, wherein the barrier state is indicative of at least one of a presence, an absence, or an incursion of the first barrier, the second barrier, or both the first and the second barriers;
monitoring, via the at least one controller, at least one of the incursion of the first barrier, the second barrier, both the first barrier and the second barrier, or an order of the incursion of the first barrier and the second barrier by the at least one machine based on the monitored barrier state;
correlating, via the at least one controller, the monitored incursion or the monitored order of the incursion with the calculated difference, the monitored first distance, the monitored second distance, or any combination thereof received from the at least one machine; and
determining, via the at least one controller, a position, a location, and/or an orientation of the at least one machine within or outside of the at least one zone based on the correlation.

14. The method of claim 13, comprising:
operating, via the at least one controller, the first barrier, the second barrier, or both the first barrier and the second barrier, wherein the first barrier, the second barrier, or both the first barrier and the second barrier correspond to at least one barricade or at least one light emitting device configured to provide a light screen as a barrier extending in a direction perpendicular to a direction of the movement of the at least one machine.

15. The method of claim 13, comprising:
providing, via the processor of the at least one machine, a unique machine identifier to the at least one controller prior to the entry or the exit from or into the at least one zone;
identifying, via the at least one controller, the at least one machine, the entry or the exit associated with the at least one zone by the at least one machine, or both the at least one machine and the entry and the exit associated with at least one zone by the at least one machine based on the unique machine identifier received from the at least one machine;
monitoring, via the at least one controller, the barrier state associated with the first barrier, the second barrier, or both the first and the second barriers provided in the at least one zone based on the identification; and
receiving, via the first barrier, the second barrier, or both the first and the second barriers, a unique barrier identifier associated with the first barrier, the second barrier, or both the first and the second barriers based on the determined incursion of the first barrier, the second barrier, or both the first and the second barriers.

16. The method of claim 13, comprising:
determining, via the at least one controller, the location of the machine traversing across the predefined zones based on at least one of the monitored incursion, the monitored order of the incursion, the monitored first distance, the monitored second distance, or the determined correlation in each zone of the predefined zones; and
performing, via the at least one controller, at least one action based on the determined location, wherein the at least one action corresponds to halting, shutting down or allowing the at least one machine to pass across one or more zones of the predefined zones based on the determined location.

17. The method of claim 13, comprising:
detecting, via the at least one controller, the incursion of the first barrier or the second barrier associated with the entry or the exit of the at least one zone by an object different from the at least one machine;
determining, via the at least one controller, a unique object identifier associated with the object associated with the incursion and a unique machine identifier of the at least once machine, wherein the object and the at least one machine are configured to provide the unique object identifier and unique machine identifier to the at least one controller respectively prior to the entry or the exit, or the unique object identifier associated with the object is indeterminate or null; and
performing, via the at least one controller, at least one action when the determined unique object identifier is indeterminate, null, or different from the determined unique machine identifier.

18. The method of claim 17, comprising:
monitoring, via the at least one controller, a distance of the object from the first and the second barriers at the entry or the exit of the at least one zone respectively; and
determining, via the at least one controller, at least one of a position, a location, or an orientation of the object on either side of the first barrier, the second barrier, or both the first barrier and the second barrier based on the monitored distance or a calculated difference in the monitored distance.

19. The method of claim 17, wherein the at least one action corresponds to halting or shutting down the at least one machine.

20. The method of claim 18, wherein the at least one action corresponds to:
halting or shutting down, via the at least one controller, the at least one machine when the determined location or the position of the object is proximate to the determined location or position of the machine or when the determined location or position of the object and the at least one machine based on at least one of the monitored distance, the monitored first distance, the monitored second distance, or the determined difference indicates the movement of the object and the at least one machine towards each other; or
allowing, via the at least one controller, the at least one object, the at least one machine, or both the at least one object and the at least one machine to traverse across the at least one zone when the determined location or position of the object and the at least one machine based on at least one of the monitored distance, the monitored first distance, the monitored second distance, or the determined difference indicates the movement of the object and the at least one machine in a same direction.
